(19) United States
(12) Patent Application Publication
(10) Pub. No.: US 2026/0014483 A1
(43) Pub. Date: Jan. 15, 2026

(54) COMPUTER SYSTEM, COMPUTER-IMPLEMENTED METHOD, AND GAME APPARATUS

(71) Applicant: Nintendo Co., Ltd., Kyoto (JP)

(72) Inventors: Minori KOIKE, Kyoto (JP); Naoki YAMAOKA, Kyoto (JP); Masahiro SHIMIZU, Kyoto (JP); Satoshi KAWAMATA, Kyoto (JP); Masayoshi KOBAYASHI, Kyoto (JP); Naoki HATTA, Kyoto (JP); Akifumi FUJITA, Kyoto (JP); Toshiaki OOMORI, Kyoto (JP); Shinji HORIGUCHI, Kyoto (JP)

(21) Appl. No.: 19/265,863

(22) Filed: Jul. 10, 2025

(30) Foreign Application Priority Data
Jul. 12, 2024 (JP) 2024-112756

(51) Int. Cl. A63F 13/86; A63F 13/35

(52) U.S. Cl. CPC A63F 13/86; A63F 13/35

(57) ABSTRACT

A sharing game that is provided by one computer that executes a game program and in which another computer is allowed to participate without executing the game program, is executed by performance of voice chat between computers in a group and communication of operation data and game image data. Included is any one of executing, as a host, processes including a game process based on operation data of a self-computer and operation data of another computer serving as a guest obtained by communications to generate a game image, and transmission of the generated game image data to the another one of the plurality of computers serving as a guest, or executing, as a guest, such processes. The executing the processes is allowed to be activated no matter whether or not the executing the processes is performed by another computer in a group.

### CROSS REFERENCE TO RELATED APPLICATION

This application claims priority to Japanese Patent Application No. 20204-112756, filed on Jul. 12, 2024, the entire contents of which are incorporated herein by reference.

### FIELD

The technology disclosed herein relates to computer systems in which a game is played using a plurality of game apparatuses, computer-implemented methods, and game apparatuses.

### BACKGROUND AND SUMMARY

There has conventionally been a technology for executing a game that is played between a plurality of computers with one of the plurality of computers set as a host computer and the other computers set as a guest computer, images being distributed from the host computer to the guest computers.

However, for such computers, there is room for improvement of communication functions such as voice chat and video chat between the computers.

The present example discloses a computer system, computer-implemented method, and game apparatus that have the function of distributing images from a host apparatus to a guest apparatus, and are capable of executing a game in novel and various ways,

The present example may have the following features (1) to (6), for example.

(1) An example configuration of a computer system according to the present example is a computer system comprising a plurality of computers, wherein each computer comprises one or more processors and one or more memories storing instructions, each computer is configured to perform operations comprising: forming a group including the plurality of computers, and performing voice chat by communication of audio data in the group through or without through a server; and executing a sharing game that is provided by one of the plurality of computers that executes a game program and in which another one of the plurality of computers is allowed to participate without executing the game program, by communication of operation data and game image data between the plurality of computers, and the executing the sharing game includes any one of executing, as a host, host processes including a game process based on operation data of a self-computer and operation data of another one of the plurality of computers serving as a guest obtained by communications to generate a game image, and transmission of the generated game image data to the another one of the plurality of computers serving as a guest, or executing, as a guest, guest processes including transmission of the operation data of the self-computer to another one of the plurality of computers serving as a host, reception of game image data from the another one of the plurality of computers serving as a host, and displaying of a game image, and the executing the host processes is allowed to be activated no matter whether or not the executing the host processes is performed by another one of the plurality of computers in the group. It should be noted that voice chat can be performed while video information is shared (so-called video chat), and thus, encompasses such a form.

With the configuration of (1), in the plurality of computers in the group, a plurality of executions of a sharing game can be activated. In addition, voice chat can be performed between the computers belonging to the group, and participants in a sharing game can be recruited. Therefore, a session for performing a sharing game can be easily formed. In addition, a plurality of sharing games can be activated in the group, and therefore, a variety of games can be played while communication is performed in the group.

(2) In the configuration of (1), the operations may further comprise sharing game images displayed on screens of at least four other ones of the plurality of computers belonging to the group of the self-computer, by simultaneously outputting and displaying the game images to and on a screen of the self-computer.

With the configuration of (2), images of a plurality of sharing games can be displayed, so that the members belonging to the group can perform game play while viewing play in the sharing games.

(3) In the configuration of (1) or (2), the executing the host processes may further include: transmitting invitation data to the sharing game to another one of the plurality of computers, the another one of the plurality of computers receiving the invitation data and transmitting participation data in response to the reception, thereby setting a member of the sharing game; displaying, as a candidate for a transmission destination of the invitation data, candidates including at least another one of the plurality of computers belonging to the group of the self-computer; selecting a transmission destination from the displayed candidates according to a user's operation, and transmitting the invitation data to the transmission destination selected by the selecting a transmission destination, and the candidates may include only one or ones of the plurality of computers in the group of the self-computer.

With the configuration of (3), only members belonging to the self-group can be invited to multiplayer play of a sharing game. Therefore, multiplayer play in a sharing game in the group can be made more enjoyable.

(4) In the configuration of any one of (1) to (3), a communications channel for executing the voice chat may be different from a communications channel for executing the sharing game.

With the configuration of (4), data communication in which a plurality of functions in the system are stabilized can be carried out using different communications channels.

(5) In the configuration of (2), the operations may further comprise displaying an indication indicating that the sharing game is being executed, in association with display of a game image displayed on the screen of the self-computer.

With the configuration of (5), a game image of members that are performing sharing play can be easily identified.

(6) In the configuration of any one of (1) to (5), the executing the host processes may further include: transmitting invitation data to the sharing game to another one of the plurality of computers, the another one of the plurality of computers receiving the invitation data and transmitting participation data in response to the reception, thereby setting a member of the sharing game; and transmitting the invitation data to another one of the plurality of computers that has already been executing, as a guest, the sharing game with still another one of the plurality of computers, and the executing the guest processes may further include: receiving the invitation data from another one of the plurality of computers during execution of the sharing game, and transmitting participation data in response to the received invitation data, thereby executing, instead of the sharing game that is being executed, another sharing game together with the another one of the plurality of computers that has transmitted the invitation data.

With the configuration of (6), communication and game play in the group can be made more enjoyable.

In addition, the present example may be carried out in the forms of a computer-implemented method and a game apparatus.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a diagram showing a non-limiting example computer system in the present example,

FIG. 2 is a block diagram showing a non-limiting example hardware configuration of a game apparatus 1,

FIG. 3 is a block diagram showing a non-limiting example configuration of servers 101a and 101b,

FIG. 4 is a functional block diagram showing non-limiting example functions of a host apparatus and a guest apparatus during a sharing game,

FIG. 5 is a diagram showing a non-limiting example in which eight game apparatuses 1a to 1h that belong to a communication group and a game apparatus 1z that does not belong to the communication group operate in respective game modes,

FIG. 6 is a diagram showing a non-limiting example image displayed on a display 15a of a game apparatus 1a set as a first host apparatus,

FIG. 7 is a diagram showing a non-limiting example image displayed on a display 15b of a game apparatus 1b set as a first guest apparatus,

FIG. 8 is a diagram showing a non-limiting example image displayed on a display 15c of a game apparatus 1c set as a second host apparatus,

FIG. 9 is a diagram showing a non-limiting example image displayed on a display 15d of a game apparatus 1d set as a second guest apparatus,

FIG. 10 is a diagram showing a non-limiting example image that is displayed on a display 15a when a game apparatus 1a that serves as a host apparatus invites another game apparatus 1 to participate in a sharing game,

FIG. 11 is a diagram showing a non-limiting example image that is displayed on a display 15b when a game apparatus 1b receives an invitation to a sharing game from another game apparatus 1a and participates in the sharing game,

FIG. 12 is a diagram showing a non-limiting example data area set in a DRAM 13,

FIG. 13 is a flowchart showing a non-limiting example main-body function process that is executed in a game apparatus 1,

FIG. 14 is a flowchart showing a non-limiting example of the first half of a communication function process executed in a game apparatus 1,

FIG. 15 is a flowchart showing a non-limiting example of the second half of a communication function process executed in a game apparatus 1,

FIG. 16 is a subroutine showing a non-limiting example detailed member registration process that is executed in step S83 of FIG. 14,

FIG. 17 is a flowchart showing a non-limiting example game program process that is executed in a game apparatus 1,

FIG. 18 is a subroutine indicating a non-limiting example detailed game sharing mode process that is executed in step S142 of FIG. 17,

FIG. 19 is a flowchart showing a non-limiting example game sharing function process for a host that is executed in a game apparatus 1,

FIG. 20 is a flowchart showing a non-limiting example game sharing function process for a guest that is executed in a game apparatus 1,

FIG. 21 is a diagram showing non-limiting example data and programs stored in a storage 104a of a server 101a,

FIG. 22 is a flowchart showing a non-limiting example process that is executed by a server 101a,

FIG. 23 is a diagram showing non-limiting example data and programs stored in a storage 104b of a server 101b, and

FIG. 24 is a flowchart showing a non-limiting example process that is executed by a server 101b.

### DETAILED DESCRIPTION OF NON-LIMITING EXAMPLE EMBODIMENTS

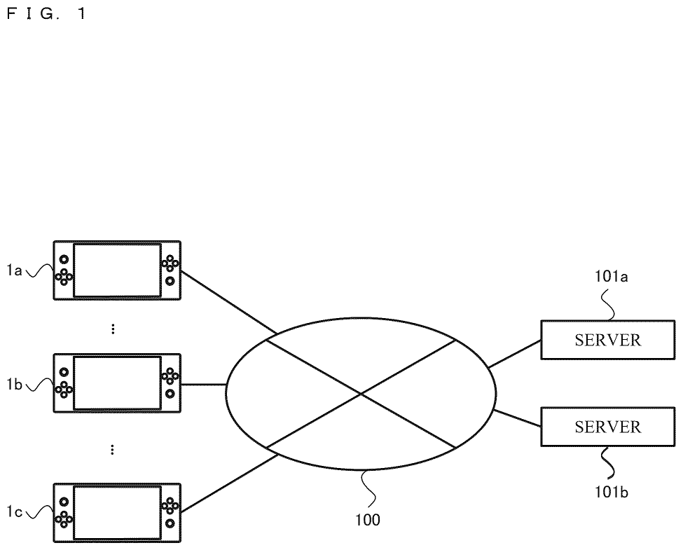

A computer system that is used in the present example will be described below. The computer system is configured by a plurality of game apparatuses 1 communicating with each other. FIG. 1 is a diagram showing an example of the computer system, illustrating an overview of a configuration of the computer system in which the plurality of game apparatuses 1 perform Internet communications through a network 100.

As shown in FIG. 1, the computer system includes a plurality of game apparatuses 1 and a plurality of servers. For example, in the computer system, game apparatuses 1a to 1c are communicably connected to servers 101a and 101b through the network 100. The game apparatuses 1a to 1c can be connected to the network 100 through Internet communications using wireless or wired communications. The game apparatuses 1a to 1c and the servers 101a and/or 101b form a client-server system. It should be noted that the game apparatuses 1a to 1c may communicate with each other without through the Internet or without through a server. For example, the game apparatuses 1a to 1c are each capable of executing a predetermined application (e.g., a game application or system application). The game apparatuses 1a to 1c are also each capable of establishing connection to the servers 101a and/or 101b through the network 100 by executing the above predetermined application, so as to communicate with the servers 101a and/or 101b. It should be noted that the number of game apparatuses 1 included in the computer system is not particularly limited. The game apparatuses 1 may each be any type of information processing apparatus, such as a game machine, smartphone, tablet terminal, or personal computer, irrespective of whether it is of the stationary or handheld type. The game apparatuses 1 may also be of different types or of the same type.

A game apparatus 1 may be designated on the network 100 from another apparatus (e.g., the servers 101a and 101b) using a network account. A temporary network account may be associated with a different game apparatus 1 each time its log-in operation is performed, for example. Alternatively, fixed network accounts may be associated with respective game apparatuses 1. Each game apparatus 1 on the network 100 may be identified using any identifier or number, a network account (user account), or an apparatus 1D uniquely assigned to the game apparatus 1.

In the present example, a plurality of game apparatuses 1 can form a communication group. The game apparatuses 1 in the communication group can share audio by communicating audio data to each other, or share images by communicating image data to each other (e.g., display the same images on the game apparatuses 1 (image sharing)), so that communication is allowed in the communication group.

In the present example, the term “sharing game” refers to a game that is played between a plurality of game apparatuses 1, and in which a game apparatus 1 that does not have a game program is allowed to participate. At least one of the plurality of game apparatuses 1 operates as a host apparatus, while another game apparatus(es) 1 operates as a guest apparatus. The host apparatus executes a game process in the sharing game, and generates a game image indicating a result of the game process. The generated game image is transmitted from the host apparatus to the guest apparatuses. The guest apparatus receives the game image from the host apparatus. The guest apparatus transmits operation data indicating an operation performed on itself (self-apparatus) by the user thereof to the host apparatus, and the host apparatus executes the game process based on the operation data.

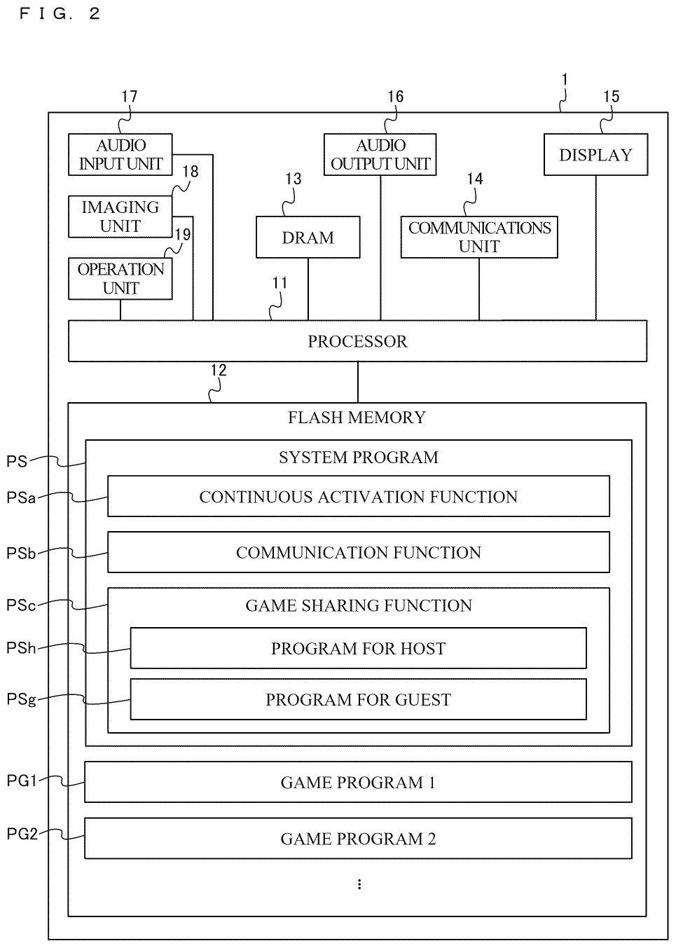

FIG. 2 is a block diagram showing an example hardware configuration of the game apparatus 1. It should be noted that in the present example, each game apparatus 1 has both a function for operating as a host apparatus and a function for operating as a guest apparatus. It should be noted that in another example, the game apparatus 1 included in the computer system may be configured to have only either of a function for operating as a host apparatus or a function for operating as a guest apparatus. In addition, as in the present example, functioning as a host apparatus may require execution of a game program.

As shown in FIG. 2, the game apparatus 1 includes a processor 11, a flash memory 12, a DRAM 13, a communications unit 14, a display 15, an audio output unit 16, an audio input unit 17, an imaging unit 18, and an operation unit 19.

The processor 11, which is an information processing unit that executes various information processes in the game apparatus 1, is connected to the units 12 to 19. For example, the processor 11 may be composed of one or more central processing units (CPUs), or may be composed of a system-on-a-chip (SoC) including one or more CPUs, one or more graphics processing units (GPUs), and the like. The processor 11 executes a program (e.g., a system program or game program) stored in a storage (specifically, an internal storage medium such as the flash memory 12, an external storage medium attached to the game apparatus 1, or the like), thereby executing various information processes.

The flash memory 12 stores various programs for causing the processor 11 to execute information processes for carrying out the communication function and executing a game. For example, the flash memory 12 stores a game program PG, and a system program PS, which is different from the game program PG. It should be noted that the game program PG may be stored in a storage medium (e.g., a memory card) that is removably attached to the game apparatus 1. In the present example, the flash memory 12 stores a plurality of different game programs (in FIG. 2, two game programs PG1 and PG2), and different games can be played by the processor 11 executing the respective game programs PG. The system program PS refers to a program that is previously installed in the game apparatus 1 no matter whether the user's instruction is present or absent. The system program PS includes a program PSa that carries out a continuous activation function that is continuously active when the power supply of the game apparatus is on, a program PSb that carries out the communication function between a plurality of game apparatuses 1, a program PSc that carries out the sharing game function of causing a plurality of game apparatuses 1 to share and play a game, and the like. The program PSc that carries out the sharing game function includes a host program PSh that is executed when the game apparatus 1 operates as a host apparatus, and a guest program PSg that is executed when the game apparatus 1 operates as a guest apparatus. The host program PSh and the guest program PSg are shared by the game programs PG (e.g., commonly used when each game program PG is executed).

The DRAM 13 is a memory that is an example storage in the game apparatus 1 and is used to temporarily store various kinds of data that are used in information processes. The DRAM 13 stores various kinds of data that are used or generated in information processes for executing the communication function and a game (e.g., a process for carrying out the communication function for executing voice chat or image sharing, a game process for causing a game to proceed, and a process for exchanging data with other game apparatuses 1 or the server 101a or 101b in order to carry out the communication function or a game). It should be noted that in the present example, voice chat can be performed while video information is shared (so-called video chat), and thus, encompasses such a form.

The communications unit 14 takes a first communications form in which the communications unit 14 can perform Internet communications, and a second communications form in which the communications unit 14 can perform local communications. In the first communications form, the communications unit 14 connects to a wireless LAN in a scheme compliant with, for example, the Wi-Fi (registered trademark) standards and thereby connects to the Internet, and communicates with another game apparatus connecting to the Internet. In the second communications form, the communications unit 14 performs direct wireless communication with another game apparatus that exists in the communication range thereof using a predetermined communications scheme (e.g., a communications scheme based on its own protocol or a scheme compliant with the Wi-Fi standards). It should be noted that the communication method with which game apparatuses in the computer system communicate with each other is not particularly limited, and may be performed either through wired communications or through wireless communication.

The display 15 displays an image based on a display control process executed by the processor 11. It should be noted that in another example, the game apparatus 1 may not be equipped with the display 15, and may be configured to cause a display apparatus that can communicate with the game apparatus 1 to display an image.

The audio output unit 16 generates audio (e.g., game sounds or a user's voice in voice chat) based on audio data output from the processor 11. For example, the audio output unit 16 includes a codec circuit and a loudspeaker. It should be noted that in another example, the game apparatus 1 may not be equipped with at least a portion of the audio output unit 16, and may be configured to output audio from a loudspeaker connected to the game apparatus 1.

The audio input unit 17 collects sounds around the game apparatus 1 and outputs audio data of the sounds to the processor 11. For example, the audio input unit 17 includes a codec circuit and a microphone, and outputs, to the processor 11, audio data based on voices of the user of the game apparatus 1 collected by the microphone. It should be noted that in another example, the game apparatus 1 may not be equipped with at least a portion of the audio input unit 17, and may be configured to collect audio using a microphone connected to the game apparatus 1.

The imaging unit 18 includes a camera that captures an image of the real world around the game apparatus 1, and outputs the captured image data to the processor 11. It should be noted that in another example, the game apparatus 1 may not be equipped with the imaging unit 18, and may be configured to capture an image using a camera connected to the game apparatus 1.

The operation unit 19 detects an operation performed on the game apparatus 1 by the user, and outputs operation data indicating the detected operation. The operation unit 19 may, for example, include operation parts such as an analog stick and buttons, and sensors such as a gyroscopic sensor and an acceleration sensor. It should be noted that in another example, the operation unit 19 may be configured to obtain operation data from a controller that is capable of communicating with the game apparatus 1 and is equipped with an operation unit.

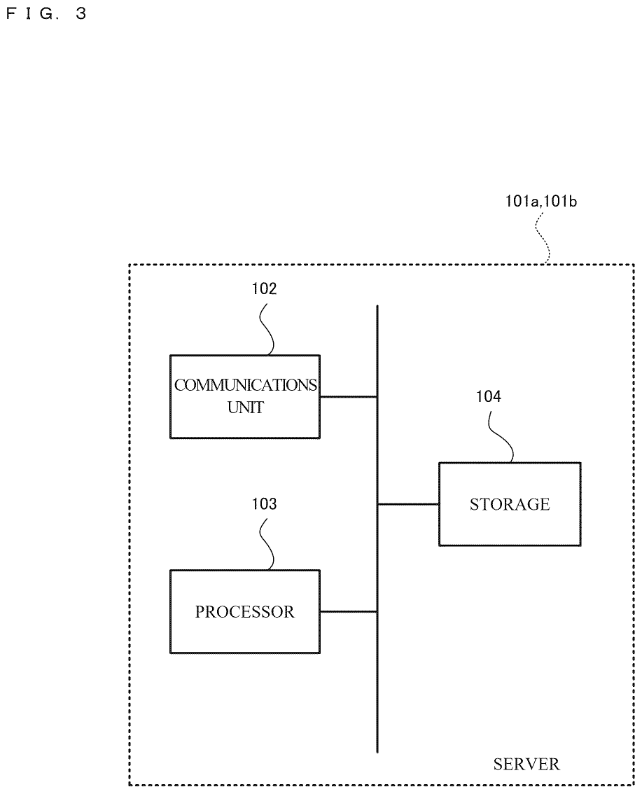

As shown in FIG. 3, the servers 101a and 101b each have a communications unit 102, a processor 103, and a storage 104. The communications unit 102 communicates with the game apparatus 1 and the like by exchanging communications packets through the network 100. As an example, the processor 103 of the server 101a executes the process of managing the communication function performed between the server 101 and the game apparatus 1, and the like, and in addition, establishes a communication link to the game apparatus 1 and the like through the communications unit 102, and performs data transmission control and routing on the network 100. The processor 103 of the server 101b executes the process of managing the game sharing function performed between the server 101b and the game apparatus 1, and the like, and in addition, establishes a communication link to the game apparatus 1 and the like through the communications unit 102, and performs data transmission control and routing on the network 100. The storage 104 stores a program executed in the processor 103, various kinds of data required for the above process, various kinds of data required for communication with the game apparatus 1, and the like. It should be noted that in the case of a system in which a predetermined log-in process is required for data exchange performed through the network 100 or participation in a game, the servers 101a and/or 101b may execute an authentication process to determine whether or not a user that is trying to log in is an authorized user. In addition, the servers 101a and 101b may each be a single server machine or may include a plurality of server machines.

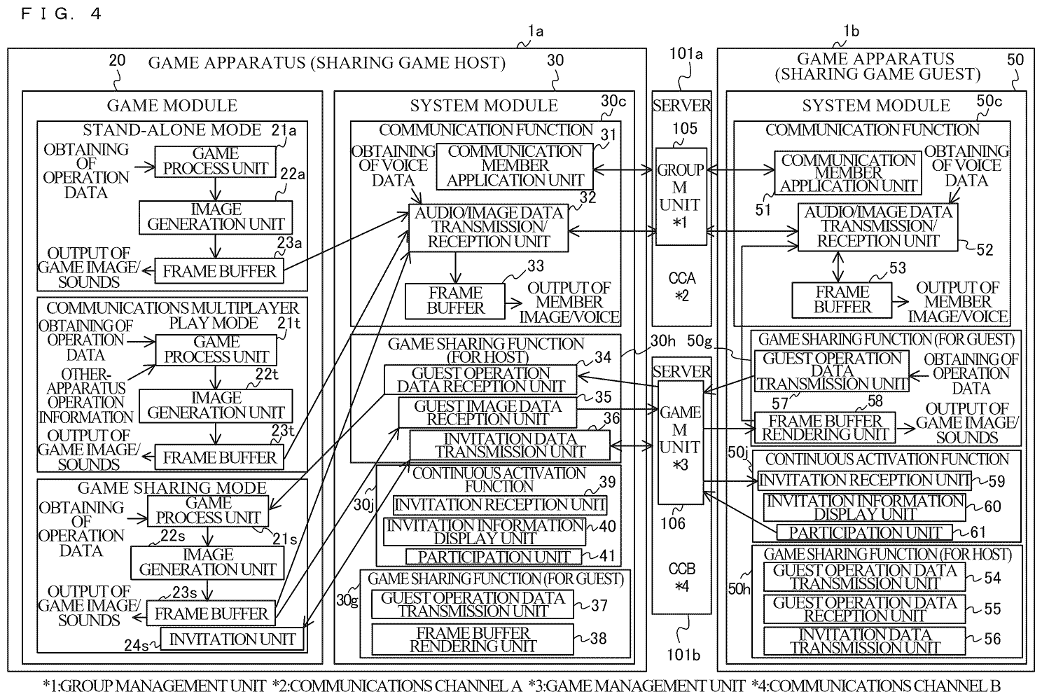

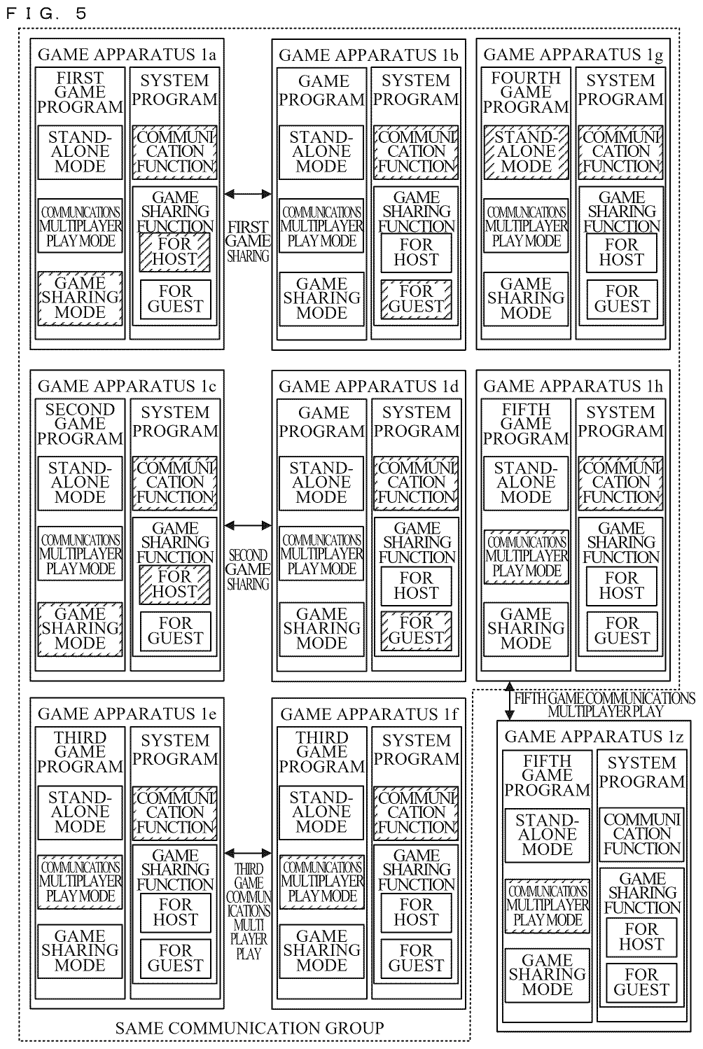

An operation that is performed by each game apparatus 1 when a game is played in the computer system will be outlined below with reference to FIGS. 4 and 5. In the description using FIG. 4, a game apparatus 1a operates as a host apparatus during a sharing game, and a game apparatus 1b operates as a guest apparatus during the sharing game, for example.

FIG. 4 is a functional block diagram showing example functions of a host apparatus and a guest apparatus during a sharing game.

The game apparatus 1a that serves as a host apparatus includes a game module 20 that is carried out based on execution of the game program PG, and a system module 30 that is carried out based on execution of the system program PS. The game module 20 carries out different functions in different game modes executed by the game apparatus 1a. For example, the game apparatus 1a has a function corresponding to each of a stand-alone mode in which the game apparatus 1a executes a game process alone, a communications multiplayer play mode in which a plurality of game apparatuses 1 execute the same game program to execute a game process while communicating with each other, and a game sharing mode in which while a host apparatus and a guest apparatus communicate with each other, the host apparatus executes a game program to execute a game process so as to display a game image on itself and transmits the game image to the guest apparatus. Specifically, the game apparatus 1a includes units 21a to 23a as a function corresponding to the stand-alone mode, units 21t to 23t as a function corresponding to the communications multiplayer play mode, and units 21s to 24s as a function corresponding to the game sharing mode.

The game process unit 21a executes a game process for causing a game to proceed in the stand-alone mode (e.g., the process of controlling each object in a game space, or the process of updating a parameter indicating a game situation). The game process unit 21a obtains operation data of the self-apparatus, and outputs, to the image generation unit 22a, a game parameter indicating a result of a game process based on the operation data (e.g., a parameter indicating the position, state, or the like of each object in a game space, or a parameter indicating a game situation).

The image generation unit 22a outputs and generates a game image in a frame buffer 23a based on a game parameter output from the game process unit 21a. The data of the game image thus generated is output to an audio/image data transmission/reception unit 32 included in the system module 30 so that an image to be displayed on the self-apparatus is shared with another game apparatus 1. A game image rendered in the frame buffer 23a by the image generation unit 22a is output to the display 15 of the self-apparatus. It should be noted that the game module 20 (e.g., an audio generation unit) generates game sounds accompanying the game image, and outputs the generated game sound data to the audio output unit 16 of the self-apparatus.

The game process unit 21t executes a game process for causing a game to proceed in the communications multiplayer play mode. The game process unit 21t obtains operation data of the self-apparatus and operation data of another game apparatus 1 that performs communication in communications multiplayer play, and outputs, to the image generation unit 22t, a game parameter indicating a result of a game process based on the operation data.

The image generation unit 22t outputs and generates a game image in a frame buffer 23t based on a game parameter output from the game process unit 21t. The data of the game image thus generated is output to the audio/image data transmission/reception unit 32 included in the system module 30 so that an image to be displayed on the self-apparatus is shared with another game apparatus 1. The game image rendered in the frame buffer 23t by the image generation unit 22t is output to the display 15 of the self-apparatus. It should be noted that the game module 20 (e.g., an audio generation unit) generates game sounds accompanying the game image, and outputs the generated game sound data to the audio output unit 16 of the self-apparatus.

The game process unit 21s executes a game process for causing a game to proceed in the game sharing mode. The game process unit 21s obtains operation data of the self-apparatus (host apparatus) and operation data of a guest apparatus output from a guest operation data reception unit 34 included in a game sharing function (for a host) 30h of the system module 30, and outputs, to the image generation unit 22s, a game parameter indicating a result of a game process based on the operation data.

The image generation unit 22s outputs and generates a game image in a frame buffer 23s based on a game parameter output from the game process unit 21s. The image generation unit 22s generates at least one game image that is to be displayed on a host apparatus and a guest apparatus that are executing a sharing game. A game image for a host apparatus may be the same as or different from a game image for a guest apparatus. When these game images are different from each other, the image generation unit 22s generates the game images and renders the game images in different frame buffers. When these game images are the same as each other, the image generation unit 22s generates only one game image. In the case in which there are a plurality of guest apparatuses, the image generation unit 22s may generate the same game image for all guest apparatuses or different game images for different guest apparatuses.

The image generation unit 22s generates a game image for a host apparatus and outputs the game image to the frame buffer 23s. The game image written in the frame buffer 23s is displayed on the display 15 of the game apparatus 1a. A guest image data transmission unit 35 included in the game sharing function (for a host) 30h obtains data of a game image for a guest apparatus, of the generated game images (a game image written in the frame buffer 23s in the case in which a game image for a host apparatus is the same as a game image for a guest apparatus), and transmits the data to the guest apparatus. The audio/image data transmission/reception unit 32 included in the system module 30 obtains the data of the generated game image for a host apparatus (the self-apparatus) in order to share an image to be displayed on the self-apparatus with another game apparatus 1 (image sharing), and transmits the data to members of a communication group. It should be noted that these processes executed by the guest image data transmission unit 35 and the audio/image data transmission/reception unit 32 may be repeated for each predetermined cycle in accordance with an instruction from the game module 20, or each time a new game image is rendered in the frame buffer, or in accordance with an instruction from the game module 20. It should be noted that the game module 20 (e.g., an audio generation unit) generates game sound accompanying the game image, and outputs the generated game sound data to the guest image data transmission unit 35. The game module 20 (e.g., an audio generation unit) also generates game sounds accompanying the game image, and outputs the generated game sound data to the audio output unit 16 of the self-apparatus.

The invitation unit 24s, which is for giving an invitation to a sharing game, selects another game apparatus 1 that is to be invited to a sharing game performed with the self-apparatus serving as a host apparatus, from the members of the communication group to which the self-apparatus belongs. Thereafter, the invitation unit 24s outputs a request for an invitation to the selected game apparatus 1 to play the sharing game, to an invitation data transmission unit 36 included in the game sharing function (for a host) 30h. The invitation unit 24s also sets a guest apparatus registered based on a reply from an invited game apparatus as a coplayer in the sharing game.

The system module 30 includes a communication function 30c, a game sharing function (for a host) 30h, a game sharing function (for a guest) 30g, and a continuous activation function 30j. The communication function 30c includes units 31 to 33 as the function of, together with another game apparatus 1, forming a communication group, and performing voice chat or video chat and game image sharing in the communication group. The game sharing function (for a host) 30h includes units 34 to 36 for functioning as a host apparatus when a sharing game is performed between a plurality of game apparatuses 1. The game sharing function (for a guest) 30g includes units 37 and 38 for functioning as a guest apparatus when a sharing game is performed between a plurality of game apparatuses 1. The continuous activation function 30j includes units 39 to 41 as the function of executing a main-body function process.

The communication member application unit 31 transmits information for applying for registration of the self-apparatus for the communication group, to a group management unit 105 included in the server 101a.

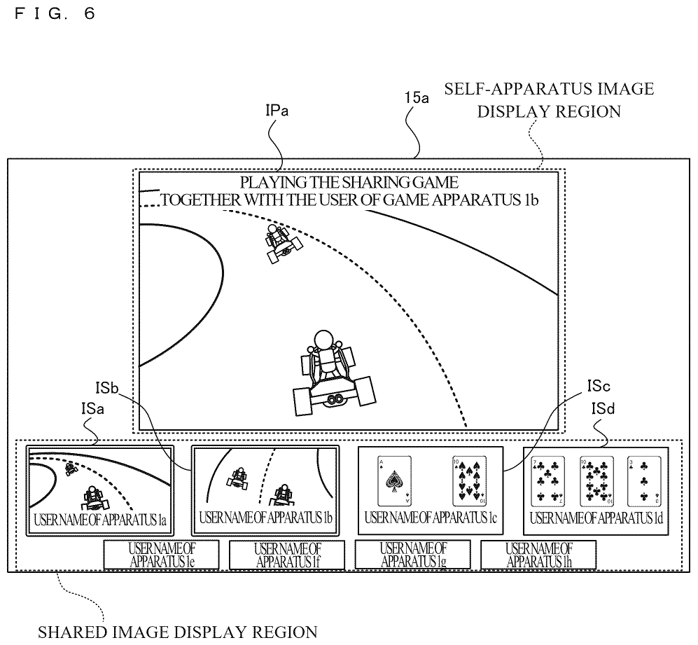

The audio/image data transmission/reception unit 32 receives a game image for image sharing from another game apparatus 1 through the server 101a, and executes a predetermined process on game image data obtained from the frame buffer of the game module 20 of the self-apparatus to generate image data for image sharing, and transmits the image data for image sharing to another game apparatus 1 through the server 101a. Specifically, the audio/image data transmission/reception unit 32 receives a game image of another game apparatus 1 that is a member of the communication group to which the self-apparatus belongs, and outputs the game image to the frame buffer 33, thereby displaying the game image on the display 15 (in FIG. 6, ISb, ISc, ISd). The audio/image data transmission/reception unit 32 also executes the process of reducing the resolution of image data of the self-apparatus generated by the image generation unit 22a, and thereafter, outputs the image data to the frame buffer 33 (in FIG. 6, ISa) and transmits the image data to the server 101a. The image data thus transmitted is transmitted to another game apparatus 1 that belongs to the above communication group and that is designated by the group management unit 105 of the server 101a. It should be noted that the audio/image data transmission/reception unit 32 transmits image data for image sharing of the self-apparatus to the server 101a in association with a communication group ID indicating the communication group to which the self-apparatus belongs and an ID indicating the self-apparatus. The audio/image data transmission/reception unit 32 also receives, from the server 101a, image data for image sharing transmitted from another game apparatus 1 belonging to the above communication group together with an ID indicating the transmission source device, and outputs the image data to the frame buffer 33, thereby displaying an image on the display 15.

The audio/image data transmission/reception unit 32 obtains the user's voice data collected by the audio input unit 17 of the self-apparatus. Thereafter, the audio/image data transmission/reception unit 32 transmits the obtained voice data to another game apparatus 1 belonging to the above communication group through the group management unit 105 included in the server 101a. It should be noted that the audio/image data transmission/reception unit 32 transmits, to the server 101a, the voice data of the self-apparatus in association with a communication group ID indicating the communication group to which the self-apparatus belongs and an ID indicating the self-apparatus. The audio/image data transmission/reception unit 32 also receives, through the group management unit 105 included in the server 101a, voice data transmitted from another game apparatus 1 belonging to the above communication group together with an ID indicating the transmission source device. It should be noted that the system module 30 (e.g., an audio generation unit) generates audio (a user's voice) based on voice data obtained by the audio/image data transmission/reception unit 32, and outputs the generated audio to the audio output unit 16 of the self-apparatus.

The frame buffer 33 renders an image for image sharing output from the audio/image data transmission/reception unit 32, e.g., images for image sharing of the self-apparatus and another game apparatus 1 belonging to the above communication group. The rendered image is displayed on the display 15 of the self-apparatus.

In order to execute a sharing game in which the self-apparatus serves as a host apparatus, the guest operation data reception unit 34 receives, through a game management unit 106 of the server 101b, operation data transmitted from a game apparatus 1 that serves as a guest apparatus in the sharing game. Thereafter, the guest operation data reception unit 34 outputs the operation data to the game process unit 21s of the game module 20 of the self-apparatus together with the ID of a game apparatus on which the operation has been performed, the ID having been transmitted in association with the received operation data of the guest apparatus.

The guest image data transmission unit 35 transmits, to the game management unit 106 of the server 101b, game image data in which a game image (for a guest apparatus) rendered in the frame buffer 23s by the image generation unit 22s of the game module 20 of the self-apparatus is associated with a game session ID. The guest image data transmission unit 35, when transmitting the game image data to the server 101b, also transmits game sound data related to the transmitted game image, in association with the game session ID.

The invitation data transmission unit 36, when receiving an instruction to transmit invitation data for a sharing game from the game module 20, transmits the invitation data together with information indicating the sharing game to the game management unit 106 of the server 101b.

When the game apparatus 1a is operating as a host apparatus, the game sharing function (for a guest) 30g in the system module 30 of the game apparatus 1a is not operating. The game sharing function (for a guest) 30g in the system module 30 of the game apparatus 1a is activated when a sharing game is performed with the game apparatus 1a serving as a guest apparatus. When activated, the game sharing function (for a guest) 30g in the game apparatus 1a carries out a function similar to a game sharing function (for a guest) 50g in a system module 50 described below of the game apparatus 1b that operates as a guest apparatus. It should be noted that in the case in which the game apparatus 1a is configured to have only functions for operating as a host apparatus, the game apparatus 1a may not include the game sharing function (for a guest) 30g.

In addition, the function of the continuous activation function 30j in the system module 30 is basically similar to a continuous activation function 50j in a system module 50 described below, and will not be herein described in detail.

The game apparatus 1b that serves as a guest apparatus includes a system module 50 that is carried out by execution of the system program PS. The system module 50 includes a communication function 50c, a game sharing function (for a host) 50h, a game sharing function (for a guest) 50g, and a continuous activation function 50j. The communication function 50c includes units 51 to 53 as the function of, together with another game apparatus 1, forming a communication group, and performing voice chat and image sharing in the communication group. The game sharing function (for a guest) 50g includes units 57 and 58 for functioning as a guest apparatus when a sharing game is played between a plurality of game apparatuses 1. The game sharing function (for a host) 50h includes units 54 to 56 for functioning as a host apparatus when a sharing game is played between a plurality of game apparatuses 1. The continuous activation function 50j includes units 59 to 61 as the function of executing a main-body function process.

The function of the communication function 50c in the system module 50 is basically similar to the function of the communication function 30c in the system module 30. It should be noted that a game image for image sharing that is transmitted by the audio/image data transmission/reception unit 52 to another game apparatus that is another member in the same communication group is not a game image generated by the image generation unit of the self-apparatus, and is a game image received from a host apparatus through the server 101b.

The guest operation data transmission unit 57 obtains operation data of the self-apparatus. Thereafter, the guest operation data transmission unit 57 transmits the obtained operation data of the self-apparatus to the game management unit 106 of the server 101b in association with the game session ID of a sharing game that is being played.

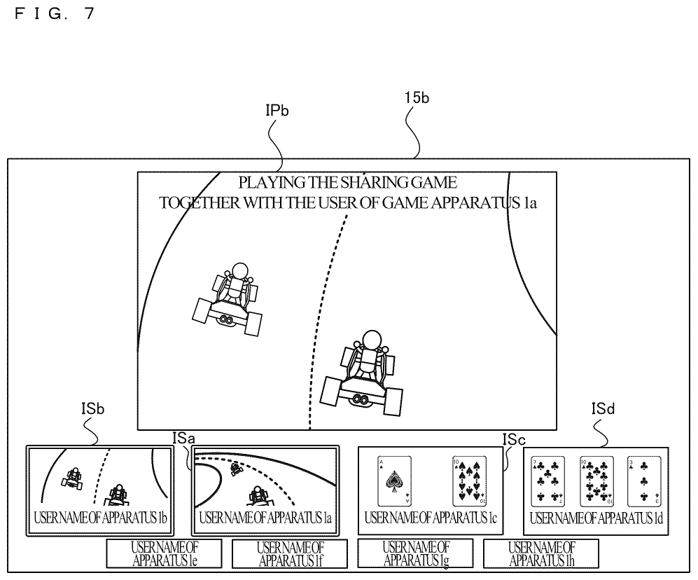

The frame buffer rendering unit 58 renders, in the frame buffer, a game image for a guest apparatus transmitted from the guest image data transmission unit 35 in the system module 30 of a host apparatus. The rendered game image is output to the display 15 of the self-apparatus (in FIG. 7 described below, IPb). The game image is also subjected to a resolution reduction process before being rendered in the frame buffer 53 (in FIG. 7 described below, ISb). It should be noted that the system module 50 (e.g., an audio generation unit) generates game sounds based on game sound data transmitted in association with the game image, and outputs the generated game sounds from the audio output unit 16 of the self-apparatus.

The invitation reception unit 59 receives invitation data transmitted from a host apparatus through the server 101b.

The invitation information display unit 60 outputs and renders, in the frame buffer of the self-apparatus, invitation information indicating details of an invitation from a host apparatus based on the received invitation data, thereby prompting the user of the self-apparatus to participate in a sharing game to which the user is invited with the invitation data.

The participation unit 61 transmits participation data indicating participation to the game management unit 106 of the server 101b in accordance with the user's operation for accepting participation in a sharing game. The participation unit 61, when receiving information indicating that the self-apparatus has been registered as a guest apparatus by the game management unit 106, sets the game session ID indicating a host apparatus registered as a coplayer of a sharing game and the sharing game.

When the game apparatus 1b is operating as a guest apparatus, the game sharing function (for a host) 50h in the system module 50 of the game apparatus 1b is not operating. When a sharing game is played with the game apparatus 1b serving as a host apparatus, the game sharing function (for a host) 50h is activated. When the game sharing function (for a host) 50h in the game apparatus 1b is activated, the game sharing function (for a host) 50h carries out a function similar to the game sharing function (for a host) 30h in the system module 30 of the game apparatus 1a that operates as a host apparatus. It should be noted that in the case in which the game apparatus 1b is configured to have only functions for operating as a guest apparatus, the game apparatus 1b may not include the game sharing function (for a host) 50h.

The server 101a includes the group management unit 105 that manages a communication group, and exchanges data with each game apparatus 1 using a communications channel A. The group management unit 105 assigns different group IDs to different communication groups, and manages members (the IDs of game apparatuses 1) belonging to a communication group based on member registration related information such as information indicating request for joining a communication group and information indicating acceptance transmitted from each game apparatus 1. The group management unit 105, when receiving data from a member belonging to a communication group, executes a process corresponding to the received data, based on member information of the communication group. For example, the group management unit 105, when receiving non-sharing player information (described below) indicating a member that does not participate in image sharing from a member belonging to a communication group, updates member information by setting the member indicated by the non-sharing player information as a member that does not share a game image of the member belonging to the communication group. The group management unit 105, when receiving image data for image sharing, transfers the image data to another member based on a communication group ID associated with the image data. At this time, the group management unit 105 transmits image data of a blank image to a member that has been set as a non-sharing player for image data for image sharing. In addition, the group management unit 105, when receiving voice data, transfers the voice data to another member based on a communication group ID associated with the voice data.

The server 101b, which includes the game management unit 106 that manages a host apparatus and a guest apparatus (e.g., the IDs of the host apparatus and the guest apparatus) that play a sharing game, exchanges data (specifically, game image data and operation data) with each game apparatus 1 using a communications channel B that is different from the communications channel A. The game management unit 106, when receiving invitation application information from a game apparatus 1, transmits invitation data to an invited member indicated by the invitation application information in association with information indicating a sharing game for which an invitation is requested using the invitation application information and an ID indicating an invitation source. The game management unit 106 manages a set of a host apparatus and a guest apparatus together with the game session ID based on the above invitation application information and participation data received from the invited member. In addition, the game management unit 106, when receiving operation data from a guest apparatus, transfers the received operation data to a corresponding host apparatus. In addition, the game management unit 106, when receiving game image data from a host apparatus, transfers the received game image data to a corresponding guest apparatus.

Thus, the function of the guest apparatus is carried out by a processor executing a system program without executing a game program. Therefore, the game apparatus 1 that serves as a guest apparatus can have the game sharing function for a guest and the communication function without installation of a specific game program. In addition, the game apparatus 1 that serves as a host apparatus can have basic portions of the game sharing function for a host and the communication function without implementation of a specific game program. As a result, it is no longer necessary to generate these functions for each game program, and therefore, the efficiency of development of a game program can be improved. In addition, since the game apparatus 1 can operate as a guest apparatus without installation of a specific game program, a sharing game can be played using a host apparatus and a guest apparatus 1f a game program is installed in the host apparatus. Thus, it is not necessary to install a game program in a guest apparatus, resulting in an improvement in convenience for the user.

In addition, in the present example, a single game apparatus 1 has a basic portion of the game sharing function for a host, and the game sharing function for a guest, due to a system program. Therefore, if a system program is previously installed in a game apparatus 1, the game apparatus 1 can operate either as a host apparatus or as a guest apparatus. Therefore, in the case in which a game is played using a game program stored in a game apparatus 1, the game can be easily played by multiple persons with the game apparatus 1 operated by the user serving as a host apparatus and game apparatuses 1 operated by other users serving as a guest apparatus. Alternatively, in the case in which a game is played using a game program stored in the game apparatus 1 of another user, the game can be easily played by multiple persons with the game apparatus 1 operated by the another user serving as a host apparatus and a game apparatus 1 operated by the user serving as a guest apparatus. This can further improve the user's convenience.

In addition, every function of the game apparatus 1 may be carried out either by execution of a game program or by execution of a system program. For example, in another example, the guest operation data reception unit of a host apparatus may be carried out by a game module by execution of a game program, and all portions of the game sharing function for a host may be carried out by execution of a game program.

In addition, information about a member of a communication group and information about a combination of a host apparatus and a guest apparatus with which a sharing game is played may be managed by a game apparatus 1. Specifically, at least one of the functions of the group management unit 105 in the server 101a and the function of the game management unit 106 in the server 101b may be provided as a function of at least one of a plurality of game apparatuses 1. In addition, information managed by the server 101a or 101b may be stored in a game apparatus 1.

In addition, one or at least three servers may control data communication between a plurality of game apparatuses 1. In the case in which a single server controls data communication between a plurality of game apparatuses 1, the server may have both the function of the group management unit 105 and the function of the game management unit 106. In that case, as to a communications channel(s) for data communication with the single server, a communications channel for use of the function of the group management unit 105 may be different from or the same as a communications channel for the use of the function of the game management unit 106.

Next, example operations of a plurality of game apparatuses belonging to a communication group will be described with reference to FIG. 5. FIG. 5 is a diagram showing an example in which eight game apparatuses 1a to 1h that belong to a communication group and a game apparatus 1z that does not belong to the communication group operate in respective game modes.

FIG. 5 shows that the game apparatuses 1a to 1h, which are within a dashed-line box, belong to the same communication group, and the game apparatus 1z, which is out of the dashed-line box, does not belong to the communication group. In addition, in FIG. 5, main functions that are being operated in each game apparatus 1 are indicated by a hatched regional block. The above communication group is constructed by each game apparatus executing a system program to operate the communication function, and therefore, the communication function is being operated in each of the game apparatuses 1a to 1h, which belong to the same communication group. Meanwhile, in the game apparatus 1z, which does not belong to the communication group, the communication function is not active.

In the present example, for the game apparatuses of a plurality of members belonging to the same communication group, a plurality of sets of a host apparatus and a guest apparatus(es) can be formed, and in each set, game sharing play in which a different game program is shared can be performed. It should be noted that the number of members that can belong to the same communication group may be limited (e.g., a maximum of 12) or may not be limited. In addition, the number of sets of a host apparatus and a guest apparatus(es) that can be formed in the same communication group and that play in the game sharing mode, e.g., a sharing play number, may be limited to a number of at least two in that communication group or may not be limited.

For example, two game apparatuses 1a and 1b belonging to the same communication group play a sharing game using a first game program in the game sharing mode with the game apparatus 1a serving as a first host apparatus and the game apparatus 1b serving as a first guest apparatus. At this time, in the game apparatus 1a serving as a first host apparatus, a game module carried out by execution of the first game program operates in the game sharing mode to execute a game process, and the game sharing function for a host that is carried out by execution of a system program operates. Meanwhile, in the game apparatus 1b serving as a first guest apparatus, a game module is not active, and the game sharing function for a guest that is carried out by execution of a system program operates.

In addition, two game apparatuses 1c and 1d belonging to the same communication group to which the game apparatuses 1a and 1b belong play a sharing game (a game different from the first game program; the game may be the same as the first game program) using a second game program in the game sharing mode with the game apparatus 1c serving as a second host apparatus and the game apparatus 1d serving as a second guest apparatus. At this time, in the game apparatus 1c serving as a second host apparatus, a game module that is carried out by execution of a second game program operates in the game sharing mode to execute a game process, and the game sharing function for a host that is carried out by execution of a system program operates. Meanwhile, in the game apparatus 1d serving as a second guest apparatus, a game module is not active, and the game sharing function for a guest that is carried out by execution of a system program operates.

Thus, in the present example, in the same communication group, a game sharing play that is performed by a first host apparatus and a first guest apparatus and another game sharing play that is performed by a second host apparatus and a second guest apparatus can be performed in parallel. In other words, a plurality of sets of game sharing functions can be activated in a communication group. In addition, voice chat and images can be shared between game apparatuses 1 belonging to the above communication group, and participants in a sharing game can be recruited, and therefore, a session for playing a sharing game can be easily formed. In addition, since a plurality of sharing games can be started in a communication group, even if there are few members possessing a game program in a communication group, a variety of game plays can be performed while communication is performed in the communication group. Therefore, communication using a game can be expected to be promoted.

Two game apparatuses 1e and 1f belonging to the same communication group each execute a third game program to play a multiplayer game in the communications multiplayer play mode. At this time, in each of the game apparatuses 1e and 1f, a game module that is carried out by execution of the third game program operates in the communications multiplayer play mode to execute a game process.

A single game apparatus 1g belonging to the same communication group plays a game in the stand-alone mode by execution of a fourth game program. At this time, in the game apparatus 1g, a game module that is carried out by execution of the fourth game program operates in the stand-alone mode to execute a game process.

In addition, a game apparatus 1h belonging to the same communication group to which game apparatuses 1e and 1f belong plays a multiplayer game together with a game apparatus 1z that does not belong to that communication group, in the communications multiplayer play mode, by execution of a fifth game program. At this time, in each of the game apparatuses 1h and 1z, a game module that is carried out by execution of the fifth game program operates in the communications multiplayer play mode to execute a game process. Thus, in the present example, a multiplayer game can be played in the communications multiplayer play mode together with the game apparatus 1z that does not belong to the same communication group.

It should be noted that in another example, a sharing game may be able to be played in the game sharing mode between game apparatuses 1 that do not belong to the same communication group. In that case, a guest apparatus may be a game apparatus 1 that belongs to the same communication group or a game apparatus 1 that does not belong to the same communication group.

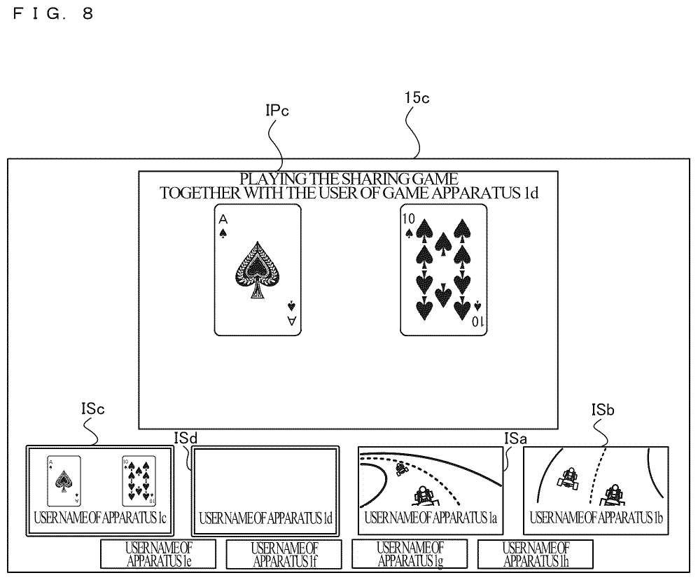

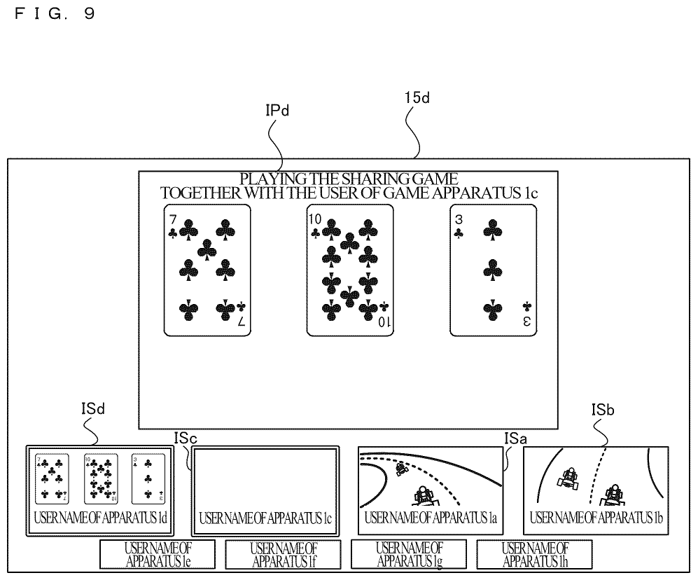

Next, an example image displayed on the display 15 of each game apparatus 1 in sharing game play will be described with reference to FIGS. 6 to 9. It should be noted that FIG. 6 is a diagram showing an example image displayed on a display 15a of a game apparatus 1a set as a first host apparatus. FIG. 7 is a diagram showing an example image displayed on a display 15b of a game apparatus 1b set as a first guest apparatus. FIG. 8 is a diagram showing an example image displayed on a display 15c of a game apparatus 1c set as a second host apparatus. FIG. 9 is a diagram showing an example image displayed on a display 15d of a game apparatus 1d set as a second guest apparatus.

In the examples described with reference to FIGS. 6 to 9, game apparatuses 1a to 1h also belong to the same communication group as described with reference to FIG. 5. The game apparatuses 1a and 1b play a sharing game using a first game program in the game sharing mode with the game apparatus 1a serving as a first host apparatus and the game apparatus 1b serving as a first guest apparatus.

In the present example, in the case in which apparatuses belonging to the same communication group display a shared image, e.g., one apparatus shares and displays an image displayed by another apparatus, a self-screen generated by a rendering process corresponding to an information process executed by the one apparatus (self-apparatus) and an image displayed by a rendering process corresponding to an information process executed by the another apparatus are simultaneously displayed on the display 15. For example, as shown in FIG. 6, the display 15 of the game apparatus 1 has a self-apparatus image display region and a shared image display region. The self-apparatus image display region covers the greatest area in the display screen of the display 15, e.g., at least half of the area of the display screen, and is located at an upper portion of the display screen. The shared image display region covers the range of the display screen of the display 15 excluding the self-apparatus image display region, e.g., less than half of the area of the display screen, and is located at a lower portion of the display screen. In the shared image display region, game images of a plurality of game apparatuses are displayed (ISa, ISb, ISc, ISd). It should be noted that in the present example, a game image of the self-apparatus is also displayed in the shared image display region (ISa).

As shown in FIG. 6, the game apparatus 1a itself serves as a host apparatus, and plays a sharing game using a first game program together with the game apparatus 1b that serves as a guest apparatus. A game image IPa obtained when the user of the game apparatus 1a plays the sharing game is displayed in the self-apparatus image display region. Specifically, a racing game that is a sharing game is performed between the game apparatus 1a and the game apparatus 1b by execution of the first game program. The game image IPa, which shows that a first player character operated by the user of the game apparatus 1a is traveling on a race track, is displayed as a self-screen image of the game apparatus 1a. A game image IPb showing that a second player character operated by the user of the game apparatus 1b is traveling on the race track is displayed as a screen image of the game apparatus 1b. In addition, in the game image IPa, sharing game identification display indicating that a sharing game is being played together with the user of the game apparatus 1b is displayed.

As shown in FIG. 7, in the game apparatus 1b, a game image IPb showing that the user of the game apparatus 1b is playing a game is displayed in the self-apparatus image display region. Specifically, the game image IPb, which shows that in the racing game performed by the game apparatus 1a executing the first game program, the second player character operated by the user of the game apparatus 1b is traveling on the same race track of the first player character, is displayed as a self-screen image of the game apparatus 1b. In addition, in the game image IPb, sharing game identification display indicating that a sharing game is being played together with the user of the game apparatus 1a is displayed.

Meanwhile, images displayed on apparatuses belonging to the same communication group are displayed in the shared image display region. As shown in FIG. 6, in the shared image display region of the display 15 of the game apparatus 1a, respective self-screen images of the other game apparatuses 1b to 1h, which belong to the same communication group, are displayed as a shared image. In addition, in the present example, a self-screen image of a self-apparatus (the game apparatus 1a) is displayed as one of shared images. In the example of FIG. 6, shared images ISa to ISd corresponding to self-screen images of the game apparatuses 1a to 1d are displayed together with the names of the users of the game apparatuses 1a to 1d in the shared image display region of the game apparatus 1a. In addition, for shared images of the game apparatuses 1e to 1h, only the names of the users of the game apparatuses 1e to 1h are displayed in the shared image display region of the game apparatus 1a, e.g., since none of the game apparatuses 1e to 1h is displaying a self-screen image, or self-image sharing is off in the game apparatuses 1e to 1h.

Thus, at least four (in the present example, four) shared images IS can be simultaneously displayed in the shared image display region of the display 15 of the game apparatus 1. As a result, game images (shared images ISa and ISb) in a first sharing game (e.g., a racing game), and game images (shared images ISc and ISd) in a second sharing game (e.g., a card game), can be displayed. Therefore, members belonging to a communication group can play a game while viewing play of sharing games performed by a plurality of sets of members.

In the present example, display indicating another apparatus that is executing a sharing game together with a self-apparatus is performed. For example, as shown in FIG. 6, the game apparatus 1a plays a sharing game together with the game apparatus 1b by execution of the first game program, and provides display “playing the sharing game together with the user of game apparatus 1b”. In addition, the shared image ISa of the game apparatus 1a and the shared image ISb of the game apparatus 1b, which indicate play of the sharing game, are displayed. The shared images ISa and ISb may be displayed in a particular form indicating that the shared images ISa and ISb are associated with each other, e.g., both of the shared images ISa and ISb are surrounded by a double-line box.

In addition, other shared images that are not associated are displayed in a display form different from the above particular display form. For example, as shown in FIG. 6, the game apparatuses 1c and 1d play a sharing game by execution of the second game program different from the game program of the game apparatuses 1a and 1b, and the shared image ISc of the game apparatus 1c and the shared image ISd of the game apparatus 1d, which display play of the sharing game, are displayed. The shared images ISc and ISd are displayed in a display form different from the above particular display form.

It should be noted that the number of shared images IS displayed in the shared image display region is not particularly limited. Not all shared images IS of members belonging to a communication group may be displayed. In addition, shared images IS displayed in the shared image display region may not include a shared image corresponding to the self-screen image of a self-apparatus (the game apparatus 1a).

In addition, as shown in FIG. 7, the game apparatus 1b displays the shared image ISb of the game apparatus 1b and the shared image ISa of the game apparatus 1a, which indicate play of a sharing game that is played together with the game apparatus 1b by execution of the first game program. Also in the game apparatus 1b, the shared images ISa and ISb are displayed in a particular display form in which both of the shared images ISa and ISb are surrounded by a double-line box, indicating that the shared images ISa and ISb are associated with each other. In addition, also in the game apparatus 1b, the shared images ISc and ISd that display play of a sharing game performed by execution of the second game program and that are different from the game apparatuses 1a and 1b are displayed. The shared images ISc and ISd are both displayed in a display form different from the above particular display form.

Thus, by displaying shared images using these display forms, the user of the game apparatus 1a can easily identify a game image displayed on the game apparatus 1b, which is performing a sharing game together with the self-apparatus. In addition, in shared images, the names of the users of the respective game apparatuses displaying the shared images are displayed, and therefore, members belonging to a communication group can know how a game is being played and can be encouraged to communicate information about game play with each other.

Meanwhile, as shown in FIG. 8, the game apparatus 1c itself serves as a host apparatus and plays a sharing game together with the game apparatus 1d, which serves as a guest apparatus, using the second game program that is different from the first game program. A game image IPc obtained when the user of the game apparatus 1c plays the sharing game is displayed in the self-apparatus image display region. Specifically, a card game is played between the game apparatus 1c and the game apparatus 1d by execution of the second game program. The game image IPc, which shows hand cards in the card game that are possessed by a third player character operated by the user of the game apparatus 1c, is displayed as a self-screen image of the game apparatus 1c. In the game image IPc, sharing game identification display indicating that a sharing game is being played together with the user of the game apparatus 1d is displayed.

In addition, as shown in FIG. 9, in the game apparatus 1d, a game image IPd obtained when a game is being played by the user of the game apparatus 1d is displayed in the self-apparatus image display region. Specifically, the game image IPd, which shows hand cards that are possessed by a fourth player character operated by the user of the game apparatus 1d in the card game performed by the game apparatus 1c executing the second game program, is displayed as a self-screen image of the game apparatus 1d. In the game image IPd, sharing game identification display indicating that a sharing game is being played together with the user of the game apparatus 1c is displayed.

In card games such as that described above, the game may not be established, if one's hand cards are seen by another player. In the present example, in the case in which a game is played in which it is not preferable that a game image of a self-apparatus be seen by a game coplayer, a blank image is set as a shared image of the game coplayer by an image sharing setting process performed by execution of a game program that carries out the game so that the game image of the self-apparatus is not displayed as a shared image on the display of the game coplayer, for example.

As shown in FIG. 8, the shared images ISa to ISd corresponding to the self-screen images of the game apparatuses 1a to 1d, which belong to the same communication group, are displayed together with the names of the users of the game apparatuses 1a to 1d in the shared image display region of the game apparatus 1c. Here, the game apparatus 1c is playing a card game as a sharing game together with the game apparatus 1d, and a blank image is displayed as the shared image ISd of the game apparatus 1d of the coplayer user. The shared images ISc and ISd are displayed in a particular display form in which both of the shared images ISc and ISd are surrounded by a double-line box, indicating that the shared images ISc and ISd are associated with each other, and that the shared image ISd is of the coplayer user. In addition, the game apparatuses 1a and 1b are playing a sharing game by execution of the first game program, which is different from that of the game apparatuses 1c and 1d, and displaying the shared images ISa and ISb showing play of the sharing game. Both of the shared images ISa and ISb are displayed in a display form different from the above particular display form.

In addition, as shown in FIG. 9, the shared images ISa to ISd corresponding to the self-screen images of the game apparatuses 1a to 1d, which belong to the same communication group, are also displayed together with the names of the users of the game apparatuses 1a to 1d in the shared image display region of the game apparatus 1d. As described above, the game apparatus 1d is playing a card game as a sharing game together with the game apparatus 1c, and a blank image is displayed as the shared image ISc of the game apparatus 1c of the coplayer user. The shared images ISc and ISd are displayed in a particular display form in which both of the shared images ISc and ISd are surrounded by a double-line box, indicating that the shared images ISc and ISd are associated with each other, and that the shared image ISc is a game image of the coplayer user. In addition, the game apparatuses 1a and 1b play a sharing game different form that of the game apparatuses 1c and 1d, and the shared images ISa and ISb are displayed, showing play of the sharing game. The shared images ISa and ISb are both displayed in a display form different from the above particular display form.

Thus, in the case in which a game is played in which it is not preferable that the game image of a self-apparatus be seen by a game coplayer, an image from which the situation of game play of the game coplayer is not known is displayed as a shared image of the game coplayer. Therefore, for a user playing such a game, even when a game coplayer belongs to the same communication group, an image that does not obstruct the game play is displayed as a shared image of the game coplayer, and therefore, a failure in game competition can be prevented. Meanwhile, as shown in FIGS. 6 and 7, even in a game in which it is not preferable that a game image be seen by a game coplayer, members of a communication group that are not involved in the game are allowed to see the game situations of all users participating in the game by viewing shared images. Therefore, communication in a communication group can be promoted.

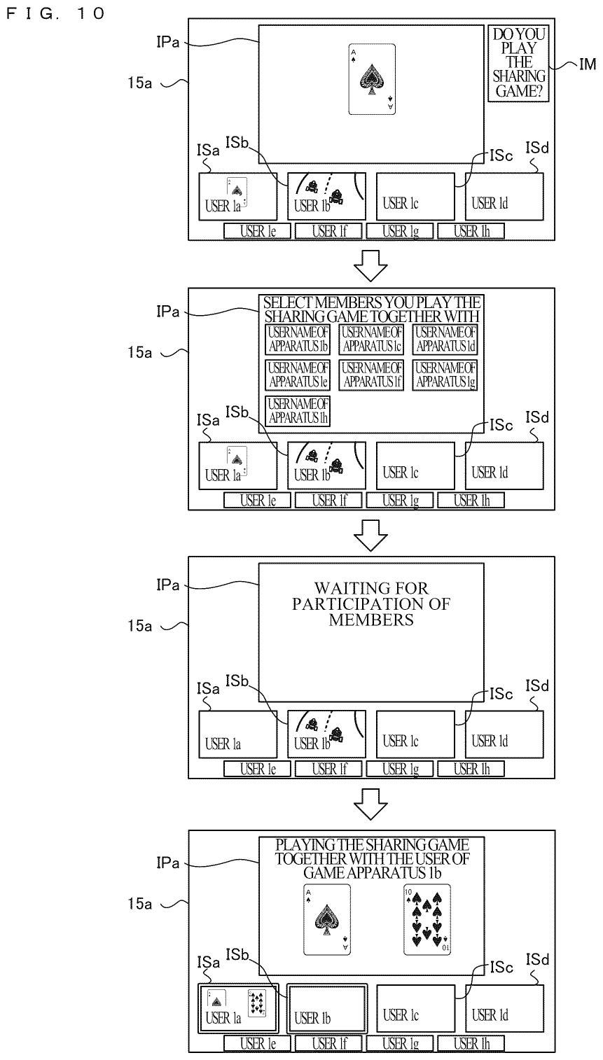

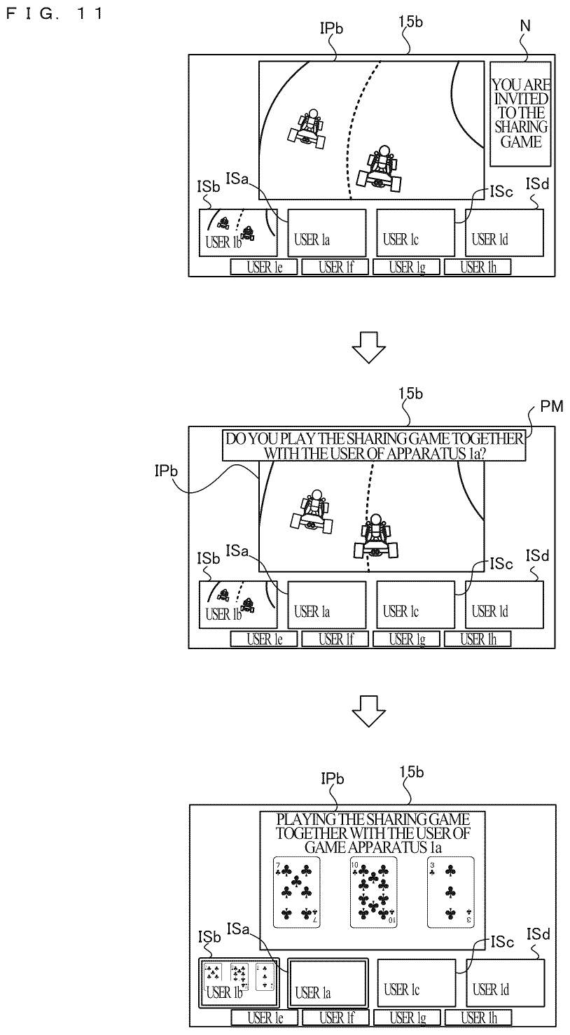

Next, an example image displayed on the display 15 of each game apparatus 1 when invited to a sharing game will be described with reference to FIGS. 10 and 11. It should be noted that FIG. 10 is a diagram showing an example image that is displayed by a game apparatus 1 that serves as a host apparatus, and that is displayed on a display 15a when a game apparatus 1a that serves as a host apparatus invites another game apparatus 1 to participate in a sharing game. FIG. 11 is a diagram showing an example image that is displayed by a game apparatus 1 that serves as a guest apparatus, and that is displayed on a display 15b when a game apparatus 1b receives an invitation to a sharing game from another game apparatus (1a) and participates in the sharing game.

In the present example, a game program executed by the processor 11 of the game apparatus 1 includes a code that causes the apparatus 1 to operate in the game sharing mode, and that causes a processor to carry out the process of activating a host function of a system program. For example, execution of the game sharing mode and activation of the host function are performed from a menu such as a top menu, or even when a game program is being executed in any game mode, activation of the game sharing mode and invitation to a sharing game can be performed from a user interface in the game program.

For example, in the top figure of FIG. 10, a game program is executed in the game apparatus 1a in one of the game modes (any of the stand-alone mode, communications multiplayer play mode, or game sharing mode), so that a game image IPa generated by the game program is displayed as a self-screen image. The display 15a of the game apparatus 1a displays a sharing game start menu IM as a user interface that prompts to execute a game program that is being started, in the game sharing mode. When the user of the game apparatus 1a performs an operation of selecting the sharing game start menu IM, the game sharing mode is activated in the game apparatus 1a with the self-apparatus serving as a host apparatus, and the game sharing function 30h for a host in the system module 30 is activated. At this time, the server 101b is notified of the activation of the game sharing mode, a session ID for a sharing game is assigned to the server 101b, and the game apparatus 1a is registered as a member serving as a host apparatus.

In the second figure from the top of FIG. 10, the display 15a of the game apparatus 1a displays options for selecting a member that is to play a sharing game together with the game apparatus 1a itself. For example, in the present example, the names of members (the name of the user of each game apparatus 1) belonging to a communication group to which a self-apparatus belongs are obtained from the server 101a, and are displayed as options. When the user of the game apparatus 1a performs an operation of selecting at least one of the options, a game apparatus 1 corresponding to the selected option is invited to a sharing game through the server 101b. As a first example, for one of the members belonging to a communication group, all members except for the one member may be displayed as the options on the display of the one member. As a second example, for one of the members belonging to a communication group, only logged-in members except for the one member may be displayed as the options on the display of the one member. As a third example, the members displayed as the options may include members belonging to other communication groups and members that do not belong to any communication group (members for which a communication function is not active). In addition, members displayed as the options may be limited to those registered as a friend.

In the third figure from the top of FIG. 10, the display 15a of the game apparatus 1a displays an indication that the game apparatus 1a is waiting for participation of members after inviting other members to participate in a sharing game in order to notify other members that the game apparatus 1a is waiting for a rely indicating participation to the invitation. The server 101b transmits invitation data to a game apparatus 1 that has been selected for the invitation as described above, and receives, from the game apparatus 1, participation data indicating participation as a reply to the invitation data, thereby executing the process of registering the game apparatus 1 as a member serving as a guest apparatus. When a host apparatus and a guest apparatus are determined for a sharing game, the server 101b transmits, to the game apparatus 1a, information indicating the determination, the game session ID indicating a sharing game performed between the host apparatus and the guest apparatus, and the like.

In the bottom figure of FIG. 10, a sharing game is started in which the game apparatus 1b, which has returned participation data in response to an invitation to the sharing game made by the game apparatus 1a, serves as a guest apparatus, and the display 15a of the game apparatus 1a displays, as a self-screen image, a game image IPa of the game apparatus 1a generated in the sharing game. In the game image IPa, sharing game identification display indicating that the sharing game is being played together with the user of the game apparatus 1b is displayed. In addition, the above self-screen image is also displayed as a shared image ISa in the shared image display region of the display 15a. It should be noted that the sharing game illustrated in FIG. 10 is a game in which it is not preferable that a shared image be seen by a game coplayer user against the self-apparatus. Therefore, a shared image ISb of the guest apparatus in the sharing game is a blank image showing only the name of the user of the game apparatus 1b.

Thus, in the present example, for one member belonging to a communication group, at least other members belonging to the communication group are displayed as options for selecting a coplayer that is to be invited to play a sharing game. Therefore, for one member belonging to a communication group, at least other members belonging to the communication group can be invited to multiplayer play in a sharing game, and therefore, multiplayer play by the sharing game in the communication group can be made more enjoyable. It should be noted that in the present example, for one member belonging to a communication group, users that do not belong to the communication group (e.g., users registered as a friend, logged-in users of the users registered as a friend, and users of other game apparatuses 1 that can perform near-field wireless communications) may also be displayed as options for selecting a coplayer that is to be invited to play a sharing game, or only members belonging to the communication group may be displayed as the options.

Meanwhile, the processor 11 of the game apparatus 1 carries out the function of accepting an invitation to a sharing game from another game apparatus 1, and the function of applying for participation in response to the invitation, by the continuous activation function in the system module 50. For example, even when the game apparatus 1 is executing a game program in any game mode, the game apparatus 1, in which the continuous activation function is active, can temporarily save a game that is being executed, and accept an invitation to a sharing game from another game apparatus 1 or apply participation in response to the invitation.

For example, in the top figure of FIG. 11, a game image IPb generated by a game program is displayed as a self-screen image by the game apparatus 1b executing the game program in one of the game modes. The display 15b of the game apparatus 1b displays a sharing game invitation notification N indicating that an invitation to a sharing game has been received from another game apparatus 1 through the server 101b.

In the middle figure of FIG. 11, the display 15b of the game apparatus 1b displays a sharing game participation menu PM as a user interface that is selected when participating in a sharing game in response to an invitation. When the user of the game apparatus 1b performs an operation of selecting the sharing game participation menu PM, a game sharing mode is activated with the game apparatus 1b itself serving as a guest apparatus, and the game sharing function 50g for a guest is activated in the system module 50. Thereafter, the game sharing function 50g for a guest transmits, to the server 101b, participation data indicating participation in a sharing game to which the user is invited. Thereafter, when a host apparatus and a guest apparatus in the sharing game are determined, the server 101b transmits, to the game apparatus 1b, information about the determination, the game session ID indicating the sharing game to be played between the host apparatus and the guest apparatus, and the like.

It should be noted that as can be seen from the self-screen image (game image IPb) in the top and middle figures of FIG. 11, in the present example, even when an invitation to a sharing game is received from another game apparatus 1, the sharing game invitation notification N or the sharing game participation menu PM is displayed with a game image being displayed while a game that is being played is continued, without interruption of the game. When the user's operation of instructing to participate in a sharing game to which the user is invited is performed, a game that is being played is interrupted, and a game changing process is started. An operation for participating in response to an invitation may be performed on an operation button (a home menu button or the like) that system software is continuously ready to receive.

In the bottom figure of FIG. 11, a sharing game has been started with the game apparatus 1a serving as a host apparatus, and a game image IPb of the game apparatus 1b generated in the sharing game is displayed as a self-screen image on the display 15b of the game apparatus 1b. The game image IPb provides sharing game identification display indicating that the sharing game is being played together with the user of the game apparatus 1a. The self-screen image is also displayed as a shared image ISb in the shared image display region of the display 15b. It should be noted that the sharing game illustrated in FIG. 11 is a game in which it is not preferable that an image of a self-apparatus be seen by a game coplayer user, and therefore, a blank image that displays only the name of the user of the game apparatus 1a is displayed as the shared image ISa of the host apparatus in the sharing game.

It should be noted that a shared image IS displayed in the shared image display region may be overlaid by a captured image of each user or an icon image of each user. In that case, the captured image or icon image of each user may be prepared in the respective game apparatus 1, and may be transmitted, together with shared image data of the respective game apparatus 1 (self-apparatus), from the respective game apparatus 1 to the server 101a. In that case, the captured image of each user may be one that is captured by the imaging unit 18 of the game apparatus 1. Image data captured in real time during data transmission to the server 101a may be added to the shared image data of the self-apparatus, and the resultant data may be transmitted.

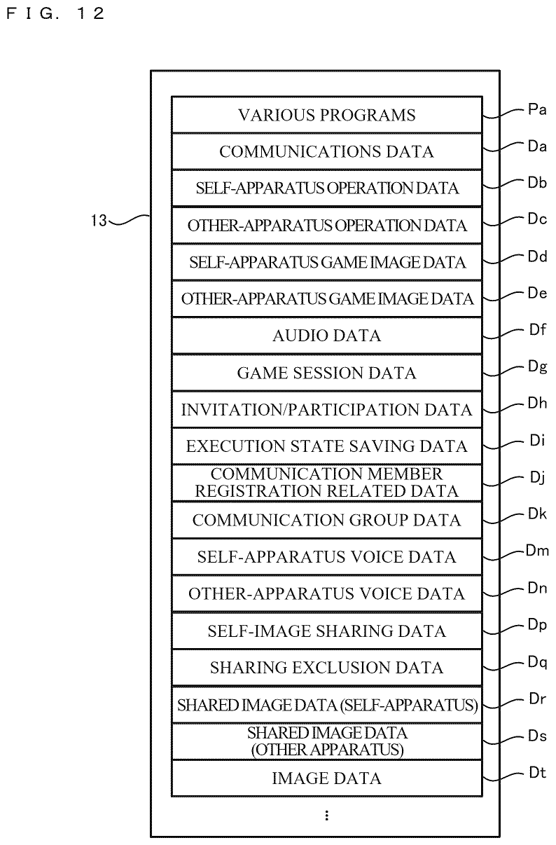

Next, an example specific process executed in the game apparatus 1 will be described with reference to FIG. 12. FIG. 12 is a diagram showing an example data area set in the DRAM 13. Although the DRAM 13 stores data used in other processes in addition to the data of FIG. 12, those other data will not be described in detail.

The DRAM 13 has a program storage area in which various programs Pa that are executed in the game apparatus 1 are stored. In the present example, the programs Pa include the system program PS, the game program PG, and the like. It should be noted that the programs Pa may be previously stored in the flash memory 12, may be obtained from a storage medium removably attached to the game apparatus 1 and then stored into the DRAM 13, or may be obtained from another apparatus through a network such as the Internet and then stored into the DRAM 13. The processor 11 executes the programs Pa stored in the DRAM 13.

The data storage area of the DRAM 13 also stores various kinds of data that are used in information processes executed in the game apparatus 1 and the like. In the present example, the DRAM 13 stores communications data Da, self-apparatus operation data Db, other-apparatus operation data Dc, self-apparatus game image data Dd, other-apparatus game image data De, audio data Df, game session data Dg, invitation/participation data Dh, execution state saving data Di, communication member registration related data Dj, communication group data Dk, self-apparatus voice data Dm, other-apparatus voice data Dn, self-image sharing data Dp, shared image data (self-apparatus) Dr, shared image data (other apparatus) Ds, image data Dt, and the like.

The communications data Da indicates data that is to be transmitted, as appropriate, to other apparatuses (e.g., the servers 101a and 101b) and data that has been received, as appropriate, from other apparatuses.

The self-apparatus operation data Db is operation data that has been obtained, as appropriate, from the operation unit 19 of the self-apparatus. For example, the operation data obtained from the operation unit 19 includes information about an input from each input unit (e.g., buttons, an analog stick, and a touch panel) (specifically, information about an operation). The self-apparatus operation data Db is updated, as appropriate, using operation data obtained from each input unit.

The other-apparatus operation data Dc is operation data that has been obtained by other apparatuses from each input unit thereof. It should be noted that operation data that has been obtained, as appropriate, by other apparatuses are transmitted to the self-apparatus through the server 101b, and is stored into the communications data Da.

The self-apparatus game image data Dd indicates an image of a game that is being played by the user of the self-apparatus, and that is displayed as a self-screen image on the display 15 of the self-apparatus. As an example, when the self-apparatus is executing a game process, the self-apparatus game image data Dd is generated based on the game process. As another example, when the self-apparatus is set in a guest apparatus and is playing a sharing game, the self-apparatus game image data Dd is transmitted from the host apparatus through the server 101b.

The other-apparatus game image data De indicates an image of a game that is being played by the user of another game apparatus 1, and is used to display the image as a self-screen image on the display 15 of the another apparatus 1. As an example, when the self-apparatus is set as a host apparatus and is executing a sharing game, the other-apparatus game image data De is game image data for a guest apparatus that is generated based on the game process that is being executed by the self-apparatus, and is transmitted, as appropriate, to the guest apparatus through the server 101b.

The audio data Df includes data of game sounds that are generated together with a game image that is obtained as a self-screen image on the display 15 of the self-apparatus, and the like, and is output to the audio output unit 16 of the self-apparatus when the game image is displayed.

The game session data Dg indicates the game session ID that is assigned when a sharing game is played together with another apparatus, details of the played sharing game, a host apparatus and a guest apparatus that are participating in the sharing game, and the like.

The invitation/participation data Dh indicates information about an invitation to a sharing game, or information about participation in a sharing game.

The execution state saving data Di saves a state of a game that has been executed before the self-apparatus transitions to the game sharing mode.

The communication member registration related data Dj indicates information about request for registration into a communication group, information about a request-to-join source, information about acceptance of request for joining a communication group, information about an acceptance source, and the like.

The communication group data Dk indicates a communication group ID indicating a communication group.

The self-apparatus voice data Dm is voice data of the user of the self-apparatus that has been collected by the audio input unit 17, and is transmitted, as appropriate, to another apparatus belonging to a communication group. The other-apparatus voice data Dn is voice data of the user of another apparatus belonging to a communication group that has been collected by the audio input unit 17 of the another apparatus. The other-apparatus voice data Dn is transmitted, as appropriate, to the self-apparatus through the server 101a and then stored into the communications data Da.

The self-image sharing data Dp indicates whether or not a game image of the self-apparatus is permitted to be displayed as a shared image on another apparatus that is a member of a communication group.

The shared image data (self-apparatus) Dr indicates a shared image that is displayed in the shared image display region of the self-apparatus, corresponding to a self-screen image of the self-apparatus (e.g., ISa in FIG. 5), and is generated, as appropriate, to have a resolution lower than that of the self-screen image. The shared image data (other apparatus) Ds indicates a shared image of another apparatus that is displayed in the shared image display region of the self-apparatus (e.g., ISb, ISc, ISd in FIG. 5), and is received, as appropriate, from the another apparatus through the server 101a. As an example, the shared image data (other apparatus) Ds is a game image of another apparatus that is executing a game in the stand-alone mode, a game image of another apparatus that is executing a game in the communications multiplayer play mode, a game image of another apparatus that is serving as a host apparatus and is executing a game in the game sharing mode, or a game image of another apparatus that is serving as a guest apparatus and is executing a game in the game sharing mode, and is obtained through the server 101a.

The image data Dt is for displaying, on the display 15 of the self-apparatus, a game image (e.g., an image of a player character, an image of a virtual object, an image of a field in a virtual space, and a background image).

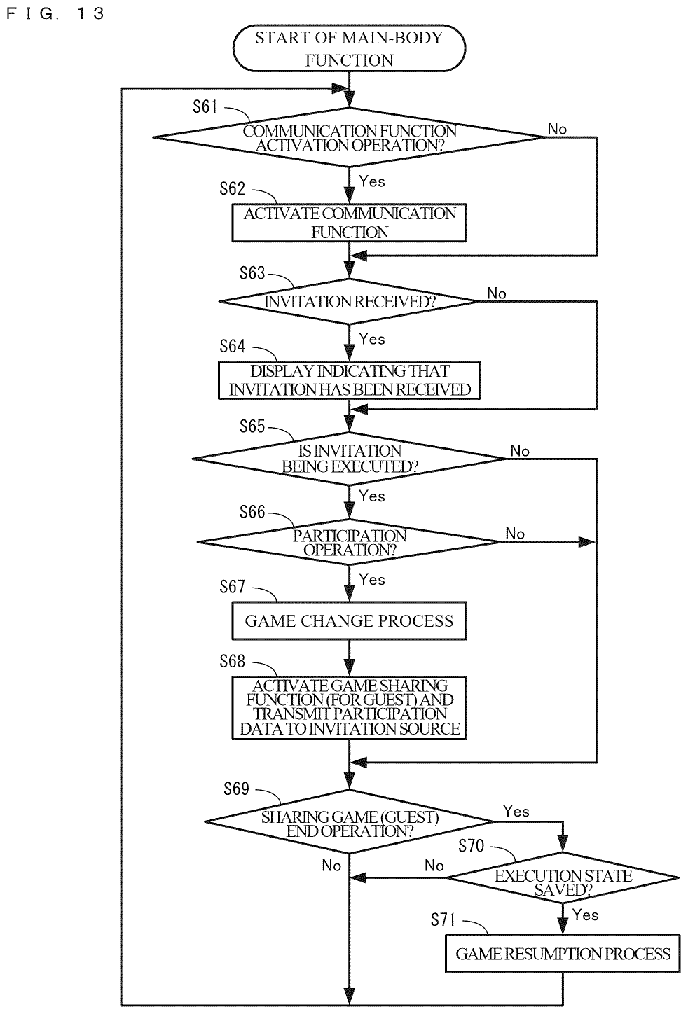

Next, an example specific main-body function process that is an example information process in the present example will be described with reference to FIG. 13. It should be noted that FIG. 13 is a flowchart showing an example main-body function process that is executed in the game apparatus 1. In the present example, a series of steps shown in FIG. 13 is continuously active when the game apparatus 1 is active, and is executed by the processor 11 executing a predetermined application program (system program) included in the programs Pa. It should be noted that the timing of start of the main-body function process of FIG. 13 is not particularly limited. As an example, the main-body function process of FIG. 13 is started at the same time when the game apparatus 1 is activated.

In FIG. 13, the processor 11 determines, with reference to the self-apparatus operation data Db, whether or not an operation of activating the communication function of the self-apparatus has been performed (step S61). If the operation of activating the communication function has been performed, the processor 11 proceeds to step S62. Otherwise, i.e., if the operation of activating the communication function has not been performed, the processor 11 proceeds to step S63.

In step S62, the processor 11 activates the communication function of the self-apparatus, and proceeds to step S63.

In step S63, the processor 11 determines, with reference to the communications data Da or the invitation/participation data Dh, whether or not invitation data for participation in a sharing game has been received from another apparatus through the server 101b. If the invitation data has been received, the processor 11 proceeds to step S64. Otherwise, i.e., if the invitation data has not been received, the processor 11 proceeds to step S65.

In step S64, the processor 11 performs control to display an indication that an invitation to participation in a sharing game has been received from another apparatus (e.g., the sharing game invitation notification N in the top figure of FIG. 11) on the display 15 of the self-apparatus, and proceeds to step S65.

In step S65, the processor 11 determines whether or not an invitation to a sharing game received from another apparatus is being processed. For example, when invitation data has been received from another apparatus and a participation operation corresponding to the invitation data has not yet been performed, the result of the determination in step S65 is positive. If the invitation is being processed, the processor 11 proceeds to step S66. Otherwise, i.e., if the invitation is not being processed, the processor 11 proceeds to step S69.

In step S66, the processor 11 determine, with reference to the self-apparatus operation data Db, whether or not an operation of participating in a sharing game in response to an invitation from another apparatus has been performed. If the operation of participating in a sharing game has been performed, the processor 11 proceeds to step S67. Otherwise, i.e., if the operation of participating in a sharing game has not been performed, the processor 11 proceeds to step S69.

In step S67, the processor 11 executes the game changing process, and proceeds to the next step. For example, if the processor 11 is executing a game (including a sharing game), the processor 11 executes, as the game changing process, the process of interrupting the game and storing the execution state of the game into the execution state saving data Di. In addition, if a sharing play function for a guest is active, the processor 11 executes, as the game changing process, the process of ending the sharing play function for a guest without saving the execution state of the sharing game.

Next, the processor 11 activates the game sharing function for a guest of the self-apparatus, and executes the process of transmitting participation data to the invitation source (step S68), and proceeds to step S69. For example, the processor 11 stores participation data indicating participation in a sharing game into the invitation/participation data Dh of an invitation source that has given an invitation to participation in the sharing game, and transmits the participation data to the server 101b.

Thus, in the present example, the process of participating in a sharing game in response to an invitation is executed by execution of a system program.

In addition, in the present example, when the game apparatus 1 is active, the above main-body function process thereof is continuously active. Therefore, even when any game program is being executed, an invitation to a sharing game can be received. It should be noted that even when a sharing game is being executed together with another game apparatus 1, an invitation to another sharing game can be received by the above main-body function process. If the operation of participating in the another sharing game in response to the invitation is performed, the another sharing game can replace and be played in a self-communication group, and therefore, communication and game play can be promoted.

In step S69, the processor 11 determines, with reference to the self-apparatus operation data Db, whether or not an operation of ending the sharing game in which the self-apparatus has been set as a guest apparatus has been performed. If the operation of ending the sharing game in which the self-apparatus has been set as a guest apparatus has been performed, the processor 11 proceeds to step S70. Otherwise, i.e., if the operation of ending the sharing game in which the self-apparatus has been set as a guest apparatus has not been performed, the processor 11 returns to and repeats step S61.

In step S70, the processor 11 determines, with reference to the execution state saving data Di, whether or not the execution state of the game has been saved in the game changing process of step S67. If the execution state of the game has been saved, the processor 11 proceeds to step S71. Otherwise, i.e., if the execution state of the game has not been saved, the processor 11 returns to and repeats step S61.

In step S71, the processor 11 executes a game resumption process, and returns to and repeats step S61. For example, the processor 11 executes the process of resuming the game interrupted in step S67 based on the execution state of the game stored in the execution state saving data Di, and deleting the execution state saving data Di.

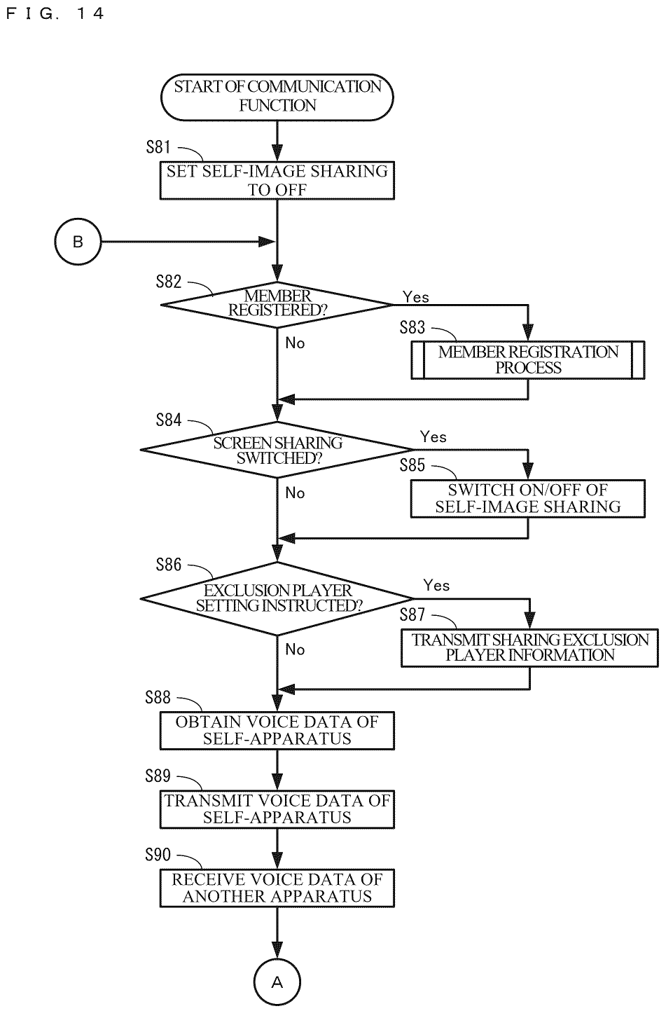

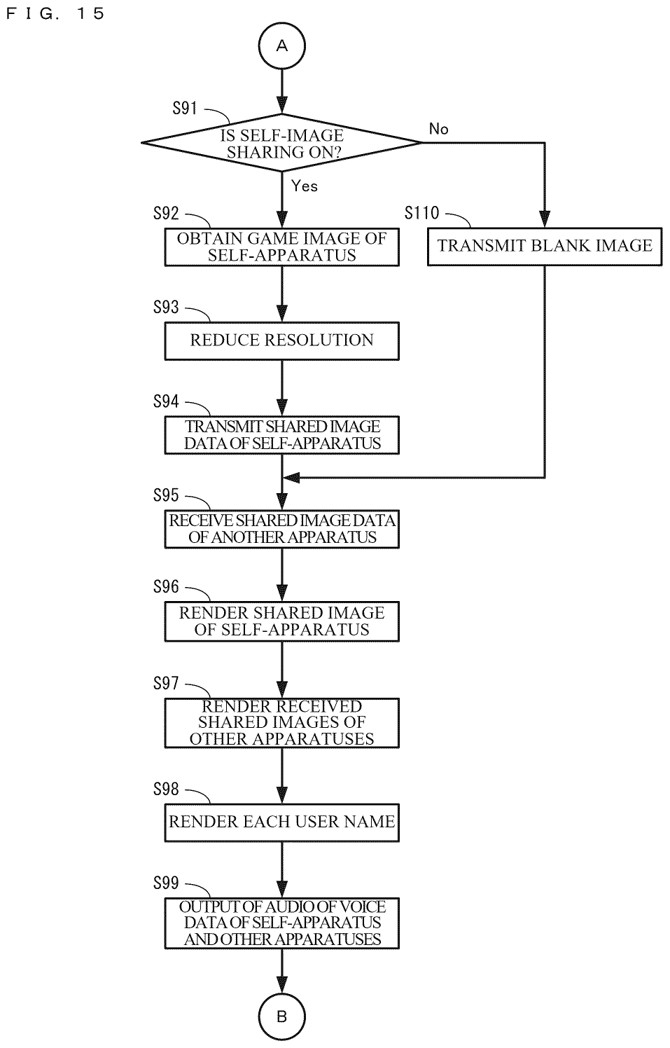

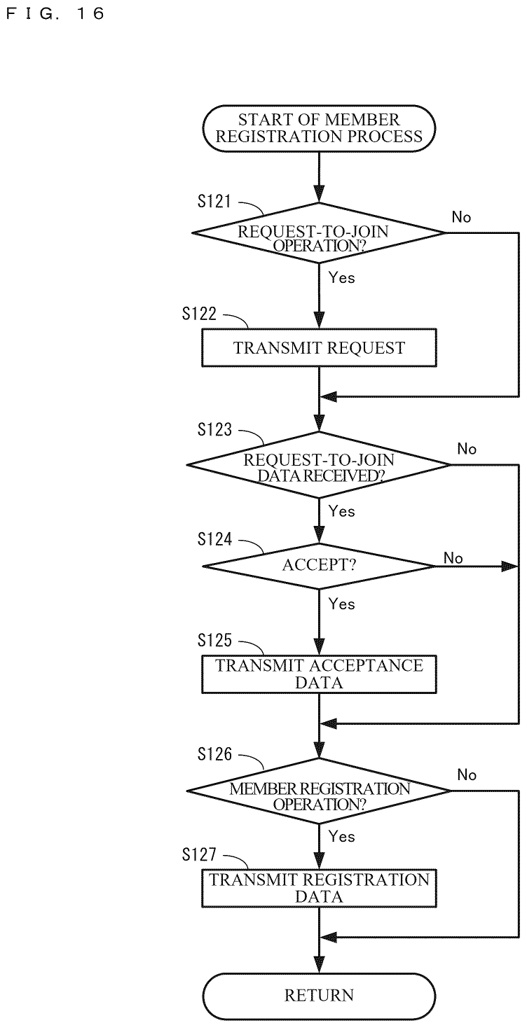

Next, an example detailed communication function process that is an example information process in the present example will be described with reference to FIGS. 14 to 16. FIG. 14 is a flowchart showing an example of the first half of the communication function process executed in the game apparatus 1. FIG. 15 is a flowchart showing an example of the second half of the communication function process executed in the game apparatus 1. FIG. 16 is a subroutine showing an example detailed member registration process that is executed in step S83 of FIG. 14. In the present example, a series of steps shown in FIGS. 14 to 16 is executed by the processor 11 executing a system program included in the programs Pa. Although the communication function process of FIGS. 14 to 16 is started in response to execution of step S62, the timing of start thereof is not particularly limited.

In FIG. 14, the processor 11 switches off an image sharing setting for permitting a self-screen image to be displayed as a shared image on another apparatus (step S81), and proceeds to the next step. For example, the processor 11 sets the self-image sharing data Dp to off.

Next, the processor 11 determines whether to execute the process of registering a member of a communication group (step S82). For example, if an operation related to member registration into a communication group has been performed on the self-apparatus or request for member registration into a communication group has been received, the result of the determination by the processor 11 in step S82 is positive. If the processor 11 determines to register a member of a communication group, the processor 11 proceeds to step S83. Otherwise, i.e., if the processor 11 does not determine to register a member of a communication group, the processor 11 proceeds to step S84.

In step S83, the processor 11 executes a member registration process, and proceeds to step S84. An example member registration process that is executed in step S83 will be described below with reference to FIG. 16.

In FIG. 16, the processor 11 determines, with reference to the self-apparatus operation data Db, whether or not an operation of requesting the user of another game apparatus 1 to join a communication group has been performed (step S121). If the operation of requesting the user of another game apparatus 1 has been performed, the processor 11 proceeds to step S122.

Otherwise, i.e., if the operation of requesting the user of another game apparatus 1 has not been performed, the processor 11 proceeds to step S123.

In step S122, the processor 11 transmits, to the server 101a, request-to-join data for request for joining a communication group, and proceeds to step S123. For example, the processor 11 stores request-to-join data indicating information about request to the user of another game apparatus 1 to join a communication group, and a request-to-join source, into the communication member registration related data Dj, and transmits the request-to-join data to the server 101a.

In step S123, the processor 11 determines, with reference to the communications data Da or the communication member registration related data Dj, whether or not request-to-join data for request for registration as a member of a communication group has been received from the user of another game apparatus 1 through the server 101a. If the request-to-join data has been received, the processor 11 proceeds to step S124. Otherwise, i.e., if the request-to-join data has not been received, the processor 11 proceeds to step S126.

In step S124, the processor 11 determines, with reference to the self-apparatus operation data Db, whether or not the user of the self-apparatus has performed an operation of accepting registration as a member of a communication group. If the user of the self-apparatus has performed an operation of accepting registration as a member of a communication group, the processor 11 proceeds to step S125. Otherwise, i.e., if the user of the self-apparatus has not performed an operation of accepting registration as a member of a communication group, the processor 11 ends the subroutine.

In step S125, the processor 11 transmits, to the server 101a, acceptance data indicating acceptance of registration as a member of a communication group, and proceeds to step S126. For example, the processor 11 stores acceptance data indicating information about acceptance of registration as a member of a communication group by the user of the self-apparatus, and a request-to-join source, into the communication member registration related data Dj, and transmits the acceptance data to the server 101a.

In step S126, the processor 11 determines, with reference to the self-apparatus operation data Db, whether or not the user of the self-apparatus has performed an operation of showing a desire for registration as a member of a communication group desired by the user. If the user of the self-apparatus has performed the operation of showing a desire for registration as a member of the communication group, the processor 11 proceeds to step S127. Otherwise, i.e., if the user of the self-apparatus has not performed the operation of showing a desire for registration as a member of the communication group, the processor 11 ends the subroutine.

In step S127, the processor 11 transmits, to the server 101a, registration data indicating a communication group for which the user of the self-apparatus desires to be registered as a member, and ends the subroutine. For example, the processor 11 stores the registration data into the communication member registration related data Dj, and transmits the registration data to the server 101a.

It should be noted that when the processor 11 receives, from the server 101a, updating data indicating that members of a communication group have been updated, the user of the self-apparatus may be notified of the updated matter using an image and/or audio.

Referring back to FIG. 14, in step S84, the processor 11 determines, with reference to the self-apparatus operation data Db, whether or not an operation of switching self-screen image sharing on/off has been performed. If the operation of switching self-screen image sharing on/off has been performed, the processor 11 proceeds to step S85. Otherwise, i.e., if the operation of switching self-screen image sharing on/off has not been performed, the processor 11 proceeds to step S86.

In step S85, the processor 11 executes the process of switching on/off of a self-image sharing setting, with reference to the self-image sharing data Dp, and proceeds to step S86. For example, if the self-image sharing data Dp indicates that the self-image sharing setting is off, the processor 11 changes the self-imaging sharing setting to on, and updates the self-image sharing data Dp. In addition, if the self-image sharing data Dp indicates that the self-image sharing setting is on, the processor 11 changes the self-image sharing setting to off, and updates the self-image sharing data Dp.

In step S86, the processor 11 determines whether or not an instruction to designate other players to be excluded from self-screen image sharing has been received. For example, if an instruction to designate other players to be excluded from image sharing has been issued by a game program process described below (e.g., step S141), the result of the determination by the processor 11 in step S86 is positive. If the instruction has been received, the processor 11 proceeds to step S87. Otherwise, i.e., if the instruction has not been received, the processor 11 proceeds to step S88. It should be noted that apart from such automatic exclusion of competition opponents, depending on the game contents of a sharing game, the user of each apparatus may designate other players that are to share a self-game image.

In step S87, the processor 11 transmits the non-sharing player information to the server 101a, and proceeds to step S88. As an example, if the user of the self-apparatus has performed an operation of designating other players to be excluded from self-screen image sharing with reference to the self-image sharing data Dp, the processor 11 generates the non-sharing player information indicating non-sharing players designated by the operation and the designation source, updates sharing exclusion data Dq, and transmits the sharing exclusion data Dq to the server 101a.

In step S88, the processor 11 obtains voice data of the self-apparatus, and proceeds to the next step. For example, the processor 11 obtains voice data of the user of the self-apparatus collected by the audio input unit 17 of the self-apparatus, and updates the self-apparatus voice data Dm.

Next, the processor 11 transmits voice data of the self-apparatus indicated by the self-apparatus voice data Dm to the server 101a (step S89), and proceeds to the next step.

Next, the processor 11 receives voice data of another apparatus, and proceeds to the next step S91 (see FIG. 15). For example, the processor 11 receives voice data of another apparatus transmitted from the server 101a, and updates the other-apparatus voice data Dn.

Referring to FIG. 15, in step S91, the processor 11 determines, with reference to the self-image sharing data Dp, whether or not the self-image sharing setting is on. If the self-image sharing setting is on, the processor 11 proceeds to step S92. Otherwise, i.e., if the self-image sharing setting is off, the processor 11 proceeds to step S110.

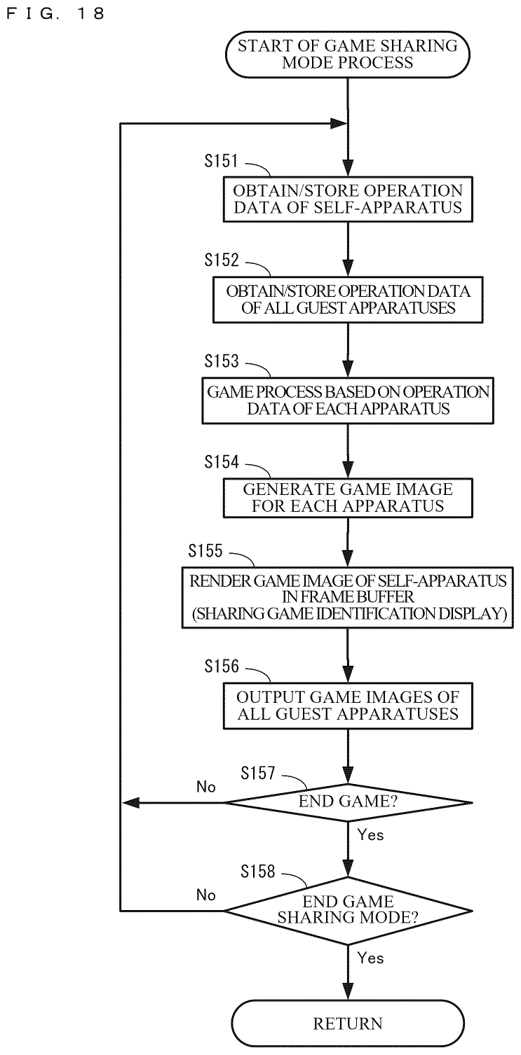

In step S92, the processor 11 obtains a game image to be displayed as a self-screen image of the self-apparatus with reference to the self-apparatus game image data Dd, and proceeds to the next step. More specifically, the processor 11 obtains, from the frame buffer or the like, a game image to be rendered in step S155 of FIG. 18 of a game program described below.

Next, the processor 11 executes the process of reducing the resolution of the game image obtained in step S92 (step S93), and proceeds to the next step. For example, the processor 11 reduces the resolution of a game image indicated by the self-apparatus game image data Dd to a predetermined level to generate a shared image of the self-apparatus, and updates the shared image data (self-apparatus) Dr using the shared image.

Next, the processor 11 transmits the shared image data of the self-apparatus generated in step S93 to another game apparatus 1 through the server 101a (step S94), and proceeds to step S95. For example, the processor 11 transmits the shared image data of the self-apparatus indicated by the shared image data (self-apparatus) Dr to the game apparatus 1 of another member through the server 101a.

If in step S91, the processor 11 determines that the self-image sharing setting is off, the processor 11 transmits data indicating a blank image as the shared image data of the self-apparatus to the game apparatus 1 of another member through the server 101a, and proceeds to step S95. It should be noted that the data indicating a blank image may be the image data of the blank image itself, or data for instructing to display the blank image.

In step S95, the processor 11 receives, from another game apparatus 1, the shared image data of the another apparatus and information about the name of a corresponding user through the server 101a, and proceeds to the next step. For example, the processor 11 updates the shared image data (other apparatus) Ds using the shared image data and user name information of another apparatus received through the server 101a. It should be noted that the user name information may be stored in each apparatus during registration into a communication group.

Next, the processor 11 performs control to render a shared image of the self-apparatus to display the shared image on the display 15 (step S96), and proceeds to the next step. It should be noted that in step S96, the communication function executes the process of instructing the GPU to perform rendering. The rendering process itself is executed by the GPU. For example, the processor 11 outputs, to the frame buffer, the shared image data (self-apparatus) Dr as image data to be displayed as a shared image of the self-apparatus in the shared image display region (e.g., the image ISa in FIG. 5) of the display 15 of the self-apparatus.

Next, the processor 11 performs control to render a shared image of another apparatus to display the shared image on the display 15 (step S97), and proceeds to the next step. For example, the processor 11 outputs, to the frame buffer, the shared image data (other apparatus) Ds as image data to be displayed as a shared image of another apparatus in the shared image display region.

Next, the processor 11 performs control to render the names of users corresponding to shared images of the self-apparatus and another apparatus, to display the user names on the display 15 (step S98), and proceeds to the next step. For example, the processor 11 obtains the name of the user of the self-apparatus and a user name corresponding to a shared image displayed in the shared image display region, and outputs an information image indicating the user name to the frame buffer such that the information image overlays a portion of the corresponding shared image.

Next, the processor 11 performs control to output audio corresponding to voice data of the self-apparatus and another apparatus (step S99), and returns to and repeats step S82 (see FIG. 14). For example, the processor 11 outputs the self-apparatus voice data Dm and the other-apparatus voice data Dn from the audio output unit 16 of the self-apparatus, and deletes voice data stored in the self-apparatus voice data Dm and the other-apparatus voice data Dn.

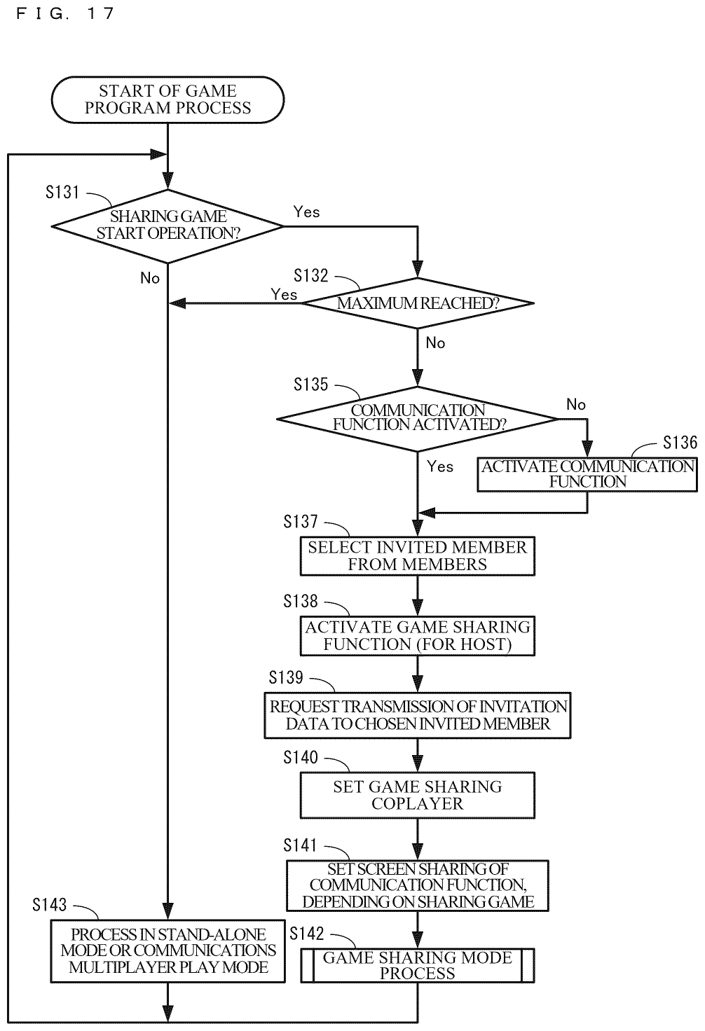

Next, an example detailed game program process will be described as an example information process in the present example with reference to FIGS. 17 and 18. FIG. 17 is a flowchart showing an example game program process that is executed in the game apparatus 1. FIG. 18 is a subroutine indicating an example detailed game sharing mode process that is executed in step S142 of FIG. 17. In the present example, a series of steps shown in FIGS. 17 and 18 is executed by the processor 11 executing a predetermined application program (game program) included in the programs Pa. It should be noted that the timing of start of the game program process of FIGS. 17 and 18 is not particularly limited.

In FIG. 17, the processor 11 determines, with reference to the self-apparatus operation data Db, an operation of starting a sharing game (e.g., an operation of selecting the sharing game start menu IM illustrated in the top figure of FIG. 10) has been performed (step S131). If the operation of starting a sharing game has been performed, the processor 11 proceeds to step S132. Otherwise, i.e., if the operation of starting a sharing game has not been performed, the processor 11 proceeds to step S143.

In step S132, the processor 11 determines whether or not the number of sharing games that are being played in the communication group to which the self-apparatus belongs has reached the maximum. For example, if the number of sharing games that are being played in the communication group to which the self-apparatus belongs has reached a predetermined threshold (e.g., a number of at least two), the result of the determination by the processor 11 in step S132 is positive. As an example, the processor 11 may obtain information about the members of the communication group from the server 101a, and information about the number of host apparatuses that are executing a sharing game from the server 101b, and calculate the number of sharing games based on these pieces of information. In addition, the processor 11 may ask the server 101b to permit starting of a sharing game, and the server 101b may determine whether or not to give the permission, depending on the number of sharing games that are being played in the same communication group. As another example, the processor 11 may manage, in the self-apparatus, the number of sharing games that are being played in the communication group to which the self-apparatus belongs. If the number of sharing games has not reached the maximum, the processor 11 proceeds to step S135. Otherwise, i.e., if the number of sharing games has reached the maximum, the processor 11 proceeds to step S143. It should be noted that if no limitation is imposed on the number of sharing games that can be simultaneously started in the same communication group, step S132 may not be executed.

In step S135, the processor 11 determines whether or not the communication function of the self-apparatus is active. If the communication function is not active, the processor 11 proceeds to step S136. Otherwise, i.e., if the communication function is active, the processor 11 proceeds to step S137.

In step S136, the processor 11 activates the communication function of the self-apparatus, and proceeds to step S137.

In step S137, the processor 11 causes an invited member selection image for inviting a member of the communication group to which the self-apparatus belongs to a sharing game (see the figure from the top of FIG. 10) to be displayed. Thereafter, the processor 11 receives the user's instruction to select an invited member. If the self-apparatus operation data Db indicates that the user's instruction has been issued, the processor 11 proceeds to the next step. It should be noted that a plurality of invited members may be selected. In addition, the processor 11 may obtain information about members of the communication group from the server 101a, and display the invited member selection image based on the information.

Next, the processor 11 activates the game sharing function for a host of the system module of the self-apparatus (step S138), and proceeds to the next step. In step S138, the processor 11 receives the game session ID from the server 101b.

Thus, in the present example, a sharing game is started by a predetermined user interface that is carried out by execution of a game program. More specifically, the game program transitions to the sharing game mode, and the host function is activated by execution of a system program. Furthermore, by execution of the game program, the process of inviting a member of the self-communication group to the sharing game is executed. Therefore, it is easier for the user to understand the procedure for activating the host function of a sharing game.

Next, the processor 11 executes the process of requesting transmission of invitation data to an invited member selected in step S137 (step S139), and proceeds to the next step. For example, the processor 11 stores invitation data for inviting the invited member to participate in a sharing game into the invitation/participation data Dh, and requests the activated game sharing function for a host to transmit the invitation data to the server 101b.

Next, the processor 11 sets a coplayer for a sharing game (step S140), and proceeds to the next step. For example, the processor 11 waits for participation information that may be transmitted from the server 101b. If the processor 11 obtains the participation information, the processor 11 sets a coplayer (e.g., the user of a guest apparatus) for a sharing game based on the participation information and the game session ID, and updates the communication group data Dk.

Next, the processor 11 executes exclusion setting for image sharing (of communication members, which apparatus does a game image to be shared belongs to, and which apparatus is the game image to be shared by?) in the communication function, depending on a sharing game to be started (step S141), and proceeds to the next step. For example, in the case of a sharing game in which the self-game image is not shared with a competition opponent (e.g., the card game shown in FIGS. 8 and 9), the processor 11 generates data for instructing the server 101b to set the competition opponents as a non-sharing player, and outputs the data to the communication function (a corresponding process is executed in step S86 of the communication function). Thus, other players excluded from image sharing are determined, depending on the contents of a sharing game, during start of the sharing game, by a game program process (e.g., step S141), and an setting instruction is transmitted to the server 101a.

Thus, in the present example, by execution of a game program, it is determined whether or not a self-game image is to be shared by a coplayer of a sharing game. Therefore, image sharing with another apparatus can be flexibly dealt with according to the contents of a game provided by execution of a game program.

Next, the processor 11 executes a game sharing mode process (step S142), and returns to and repeats step S131. An example game sharing mode process that is executed in step S142 will be described with reference to FIG. 18.

In FIG. 18, the processor 11 obtains operation data from the operation unit 19 of the self-apparatus, updates the self-apparatus operation data Db (step S151), and proceeds to the next step.

Next, the processor 11 obtains operation data of all guest apparatuses, updates the other-apparatus operation data Dc (step S152), and proceeds to the next step. For example, the processor 11 updates the other-apparatus operation data Dc using operation data of guest apparatuses and the game session ID received from the server 101b in the game sharing function for a host.

Next, the processor 11 executes a game process based on operation data of the self-apparatus (host apparatus) and another apparatus (guest apparatus) (step S153), and proceeds to the next step. The specific details of the game process of step S153 are not particularly limited. For example, the action of a player character corresponding to each apparatus may be controlled based on the operation data of the apparatus, the action of a non-player character may be controlled, a command may be selected in a game based on the operation data of each apparatus.

Next, the processor 11 executes the process of generating a game image for each apparatus based on a result of the game process of step S153 (step S154), and proceeds to the next step. For example, based on a result of the game process, the processor 11 generates a game image for the self-apparatus (host apparatus) and a game image for another apparatus (guest apparatus), and updates the self-apparatus game image data Dd and the other-apparatus game image data De. It should be noted that the generated game images may be the same image common to all of the host apparatus and the guest apparatus.

Next, the processor 11 renders a game image of the self-apparatus in the frame buffer to display the game image on the display 15 of the self-apparatus (step S155), and proceeds to the next step. For example, the processor 11 adds sharing game identification display to a game image for a host apparatus indicated by the self-apparatus game image data Dd, and renders the resultant game image in the frame buffer to display the game image in the self-apparatus image display region of the display 15 (see the game image IPa of FIG. 6 and the game image IPc of FIG. 8). It should be noted that the game image generation process of step S154 may be executed by causing the CPU to render a game image in the frame buffer. In that case, the processes of step S154 and S155 are substantially a single process. If a game image for a host apparatus is different from a game image for a guest apparatus, these images may be generated by being rendered in different frame buffers.

Next, the processor 11 executes the process of outputting a game image of another apparatus to the game sharing function for a host (step S156), and proceeds to the next step. For example, the processor 11 performs control to output game image data for a guest apparatus (e.g., as described above, data obtained by copying image data rendered in the frame buffer as a game image for a guest apparatus) stored in the other-apparatus game image data De, together with the game session ID, to the game sharing function for a host, and thereby transmit the game image data to each guest apparatus through the server 101b.

Next, the processor 11 determines whether or not to end the game (step S157). In step S157, the game is ended, for example, if a condition for ending the game is satisfied, the user has performed an operation of ending the game, or the like. If the processor 11 does not determine to end the game, the processor 11 returns to and repeats step S151. Otherwise, i.e., if the processor 11 determines to end the game, the processor 11 proceeds to step S158.

In step S158, the processor 11 determines whether or not to end the game sharing mode. In step S158, the game sharing mode is ended, for example, if a condition for ending the game sharing mode is satisfied, the user has performed an operation of ending the game sharing mode, or the like. If the processor 11 does not determine to end the game sharing mode, the processor 11 returns to and repeats step S151. Otherwise, i.e., if the processor 11 determines to end the game sharing mode, the processor 11 ends the subroutine.

Referring back to FIG. 17, in step S143, the processor 11 executes a process in the stand-alone mode or the communications multiplayer play mode, and returns to and repeats step S131. It should be noted that in step S143, based on the user's selection, the stand-alone mode or the communications multiplayer play mode is selected as a game play mode, and a game image based on a result of a game process corresponding to the mode is displayed as a self-screen image on the display 15 of the self-apparatus. The specific details of the game process are not particularly limited and will not be described in detail.

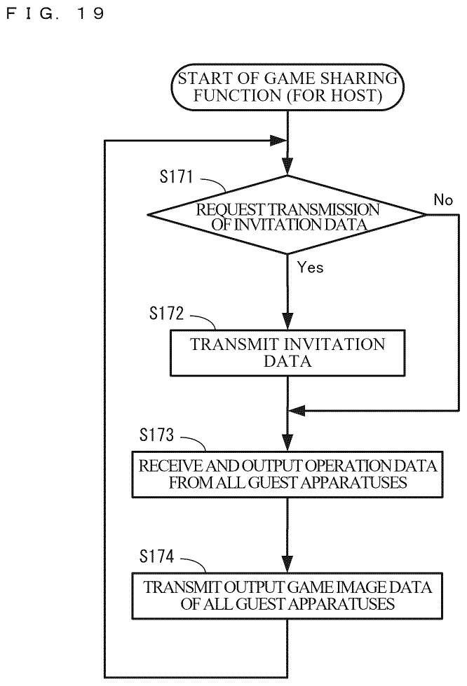

Next, a game sharing function process for a host that is an example information process in the present example will be described with reference to FIG. 19. It should be noted that FIG. 19 is a flowchart showing an example game sharing function process for a host that is executed in the game apparatus 1. In the present example, a series of steps shown in FIG. 19 is executed by the processor 11 executing a system program included in the programs Pa. It should be noted that the game sharing function process for a host of FIG. 19 is started in response to execution of step S138. The timing of start of the game sharing function process for a host is not particularly limited.

In FIG. 19, the processor 11 determines whether or not transmission of invitation data to an invited member has been requested by execution of step S139 in the game program process (step S171). If transmission of invitation data has been requested, the processor 11 proceeds to step S172. Otherwise, i.e., if transmission of invitation data has not been requested, the processor 11 proceeds to step S173.

In step S172, the processor 11 transmits invitation data to the server 101b, and proceeds to step S173. For example, the processor 11 transmits invitation data stored in the invitation/participation data Dh to the server 101b by execution of step S139.

In step S173, the processor 11 receives operation data of all guest apparatuses transmitted from the server 101b together with the game session ID, outputs the operation data and the game session ID as data used in the game program process, and proceeds to the next step.

Next, the processor 11 transmits the game image data for a guest apparatus output in the game program process together with the game session ID to the server 101b (step S174), and returns to and repeats step S171.

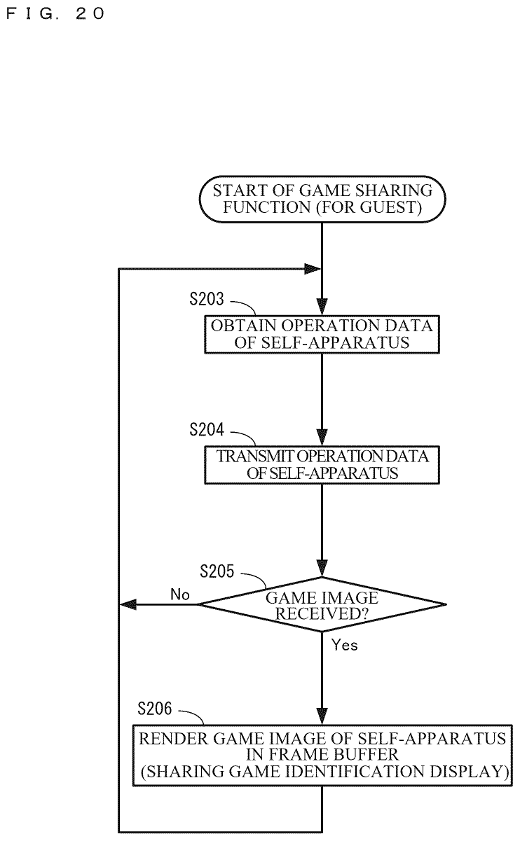

Next, referring to FIG. 20, an example detailed game sharing function process for a guest that is an example information process in the present example will be described. It should be noted that FIG. 20 is a flowchart showing an example game sharing function process for a guest that is executed in the game apparatus 1. In the present example, a series of steps shown in FIG. 20 is executed by the processor 11 executing a system program included in the programs Pa. Although the game sharing function process for a guest of FIG. 20 is started in response to execution of step S68, the timing of start of the game sharing function process for a guest of FIG. 20 is not particularly limited.

In FIG. 20, the processor 11 obtains operation data from the operation unit 19 of the self-apparatus, updates the self-apparatus operation data Db (step S203), and proceeds to the next step.

Next, the processor 11 transmits the operation data of the self-apparatus obtained in step S203 together with the game session ID to the server 101b (step S204), and proceeds to the next step.

Next, the processor 11 determines whether or not game image data for the self-apparatus (guest apparatus) has been received from the server 101b (step S205). If game image data for the self-apparatus has been received, the processor 11 proceeds to step S206. Otherwise, i.e., if game image data for the self-apparatus has not been received, the processor 11 returns to and repeats step S203.

In step S206, the processor 11 updates the self-apparatus game image data Dd using the received game image data and game session ID. Thereafter, the processor 11 performs control to render a game image indicated by the self-apparatus game image data Dd in the frame buffer, to display the game image on the display 15 of the self-apparatus, and returns to and repeats step S203. For example, the processor 11 adds sharing game identification display to the game image for a guest apparatus indicated by the self-apparatus game image data Dd, and renders the resultant game image in the frame buffer to displays the game image in the self-apparatus image display region of the display 15 (see the game image IPb of FIG. 7 and the game image IPd of FIG. 9).

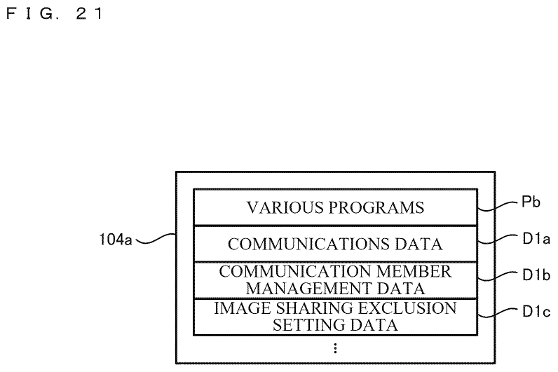

Next, data and programs stored in the storage 104a of the server 101a that are used to control the communication function will be described with reference to FIG. 21. Although the server 101a also stores data used in other processes in addition to the data of FIG. 21, such additional data will not be described in detail.

As shown in FIG. 21, the storage 104a stores, in a data storage area thereof, communications data D1a, communication member management data D1b, image sharing exclusion setting data D1c, and the like. In addition, various programs Pb for carrying out the above processes are stored in the program storage area of the storage 104a.

The communications data D1a stores, as appropriate, reception data that has been received from each game apparatus 1, and stores, as appropriate, transmission data that is to be transmitted to each game apparatus 1. It should be noted that the timing of receiving data from the game apparatus 1 and storing the data into the communications data D1a, and the timing of storing data to be transmitted to the game apparatus 1 into the communications data D1a and transmitting the data are not particularly limited, and these processes may be executed in each cycle of the process executed in the server 101a.

The communication member management data D1b indicates member information for each communication group that has been formed. For example, the member information includes a communication group ID indicating a communication group, and in addition, an apparatus 1D for each member, a user name, and the like.

The image sharing exclusion setting data D1c indicates other players (other members) that do not share the self-game image of each member belonging to a communication group.

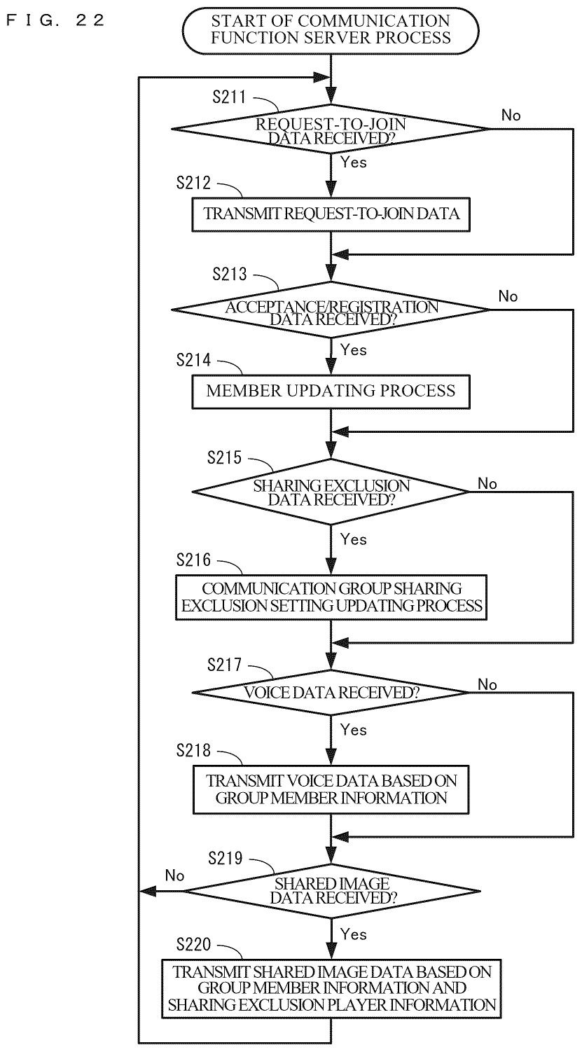

Next, a process that is executed in the server 101a to control the communication function will be described in detail with reference to FIG. 22. Here, in the flowchart of FIG. 22, steps that are executed in the server 101a to manage a communication group will be mainly described, and other steps that are not directly related to these steps will not be described in detail.

In FIG. 22, a processor 103a of the server 101a determines whether or not request-to-join data has been received from a game apparatus 1 (step S211). If request-to-join data has been received, the processor 103a proceeds to step S212. Otherwise, i.e., if request-to-join data has not been received, the processor 103a proceeds to step S213.

In step S212, the processor 103a transmits the request-to-join data to a game apparatus 1 to be requested, and proceeds to step S213. For example, the processor 103a transmits request-to-join data indicating a user that is a request-to-join source and indicating that the user as the request-to-join source requests registration as a member of a communication group, the request-to-join data being addressed to a game apparatus 1 to be requested with the request-to-join data received in step S211. It should be noted that if the user as the request-to-join source has already belonged to a communication group, the processor 103a may transmit request-to-join data to which information about the members of the communication group is added. For example, if the communication member management data D1b indicates that the user as the request-to-join source is registered as a member of a communication group, the processor 103a may transmit, to a game apparatus 1 to be requested, request-to-join data to which information about the members of the communication group and the communication group ID of the communication group are added.

In step S213, the processor 103a determines whether or not acceptance data or registration data has been received from a game apparatus 1. If acceptance data or registration data has been received, the processor 103a proceeds to step S214. Otherwise, i.e., if neither acceptance data nor registration data has been received, the processor 103a proceeds to step S215.

In step S214, the processor 103a executes a member updating process, and proceeds to step S215. As a first example, if the communication member management data D1b indicates that a user as a request-to-join source indicated by the received acceptance data does not belong to a communication group, the processor 103a generates a new communication group. Thereafter, the processor 103a registers the user as the request-to-join source and the accepted user in the acceptance data as a member of the newly generated communication group, sets a communication group ID for the communication group, and updates the communication member management data D1b. As a second example, if the communication member management data D1b indicates that a user as a request-to-join source indicated by the received acceptance data belongs to a communication group, the processor 103a registers the accepted user in the acceptance data as a member of the communication group, and updates the communication member management data D1b. As a third example, the processor 103a registers a user as a transmission source that has transmitted registration data, as a member of the communication group for which the user desires to be registered as a member, and updates the communication member management data D1b.

In step S215, the processor 103a determines whether or not sharing exclusion data has been received from a game apparatus 1. If the sharing exclusion data has been received, the processor 103a proceeds to step S216. Otherwise, i.e., if the sharing exclusion data has not been received, the processor 103a proceeds to step S217.

In step S216, the processor 103a executes the process of updating a sharing exclusion setting for the communication group, and proceeds to step S217. For example, based on the received sharing exclusion data, the processor 103a sets other players (other members) that do not share a game image of each member belonging to the communication group, and updates the image sharing exclusion setting data D1c.

In step S217, the processor 103a determines whether or not voice data has been received from a game apparatus 1. If voice data has been received, the processor 103a proceeds to step S218. Otherwise, i.e., if voice data has not been received, the processor 103a proceeds to step S219.

In step S218, the processor 103a transmits the voice data received in step S217, based on the communication member management data D1b, and proceeds to step S219. For example, the processor 103a retrieves the communication group to which the transmission source of the received voice data belongs from the communication member management data D1b, adds information about the transmission source of the voice data and the communication group ID to the voice data, and transmits the resultant voice data to the game apparatus 1 of each member of the communication group.

In step S219, the processor 103a determines whether or not shared image data has been received from a game apparatus 1. If shared image data has been received, the processor 103a proceeds to step S220. Otherwise, i.e., if shared image data has not been received, the processor 103a returns to and repeats step S211.

In step S220, the processor 103a transmits the shared image data received in step S219, based on the communication member management data D1b and the image sharing exclusion setting data D1c, and returns to and repeats step S211. For example, the processor 103a retrieves the communication group to which the transmission source of the received shared image data from the communication member management data D1b, adds information about the transmission source of the shared image data and the communication group ID to the shared image data, and transmits the resultant shared image data to the game apparatus 1 of each member of the communication group. It should be noted that if the image sharing exclusion setting data D1c indicates that the transmission source of the received shared image data is a non-sharing player, the processor 103a transmits, to the game apparatus 1 of the user corresponding to the non-sharing player, data indicating a blank image to which information about the transmission source of the shared image data and the communication group ID are added. It should be noted that the data indicating the blank image may be the image data of the blank image itself or data for instructing to display the blank image as a shared image.

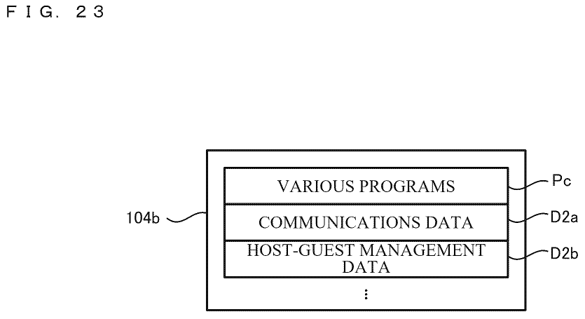

Next, data and programs stored in a storage 104b of the server 101b that are used to control the game sharing function will be described with reference to FIG. 23. Although the server 101b also stores data used in other processes in addition to the data of FIG. 23, such additional data will not be described in detail.

As shown in FIG. 23, the storage 104b stores, in a data storage area thereof, communications data D2a, host-guest management data D2b, and the like. In addition, the storage 104b stores, in a program storage area thereof, various programs Pc for carrying out the above processes.

The communications data D2a stores, as appropriate, reception data that has been received from each game apparatus 1, and stores, as appropriate, transmission data that is to be transmitted to each game apparatus 1. It should be noted that the timing of receiving data from the game apparatus 1 and stores the data into the communications data D2a, and the timing of storing data to be transmitted to the game apparatus 1 into the communications data D2a and transmitting the data are not particularly limited, and these processes may be executed in each cycle of the process executed in the server 101b.

The host-guest management data D2b indicates apparatus information for each combination of a host apparatus and a guest apparatus that are executing a sharing game. For example, the apparatus information includes the game session ID for each combination, and in addition, the apparatus 1D, the user name, the type of a played game, and the like of each of a host apparatus and a guest apparatus that are executing a sharing game.

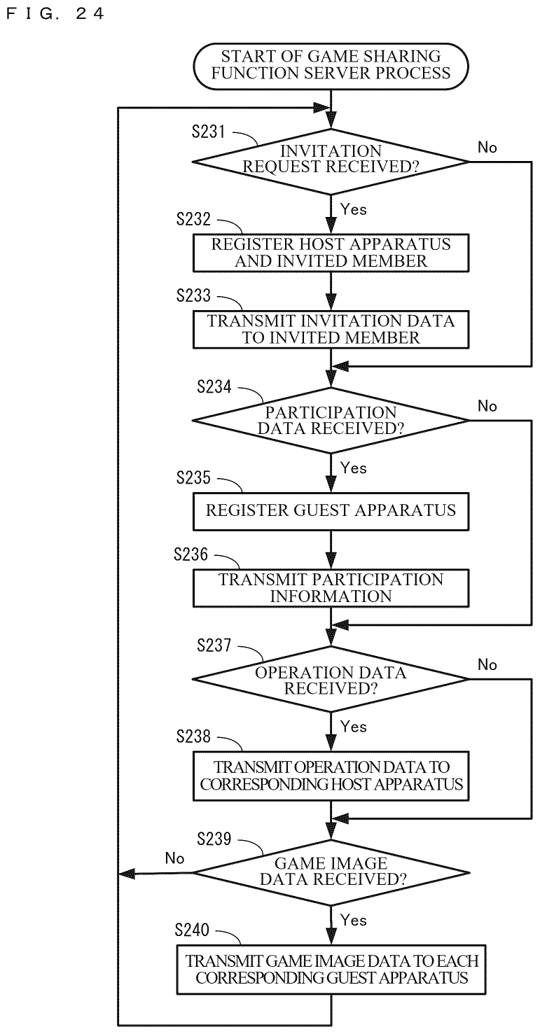

Next, a detailed process that is executed in the server 101b to control the game sharing function will be described with reference to FIG. 24. Here, in the flowchart of FIG. 24, a process that is executed in the server 101b to manage a host apparatus and a guest apparatus that play a sharing game will be mainly described, and other processes that are not directly involved with these processes will not be described in detail.

In FIG. 24, a processor 103b of the server 101b determines whether or not a game apparatus 1 has requested for transmission of invitation data (step S231). If invitation has been requested, the processor 103b proceeds to step S232. Otherwise, i.e., if invitation has not been requested, the processor 103b proceeds to step S234.

In step S232, the processor 103b registers a host apparatus and an invited member, and proceeds to the next step. For example, the processor 103b registers the apparatus 1D and user name of the invitation source that has requested for transmission of invitation data as a host apparatus, registers the apparatus 1D and user name of an invited member as a guest apparatus candidate, and updates the host-guest management data D2b.

Next, the processor 103b transmits the invitation data to the game apparatus 1 that is the invited member (step S233), and proceeds to step S234. For example, the processor 103b transmits invitation data indicating the user of an invitation source and indicating that the user of the invitation source invites to play a sharing game, the invitation data being addressed to the game apparatus 1 of the invited member in the invitation request received in step S231. It should be noted that if an invitation source has already served as a host apparatus and, together with another guest apparatus, has formed a combination for playing a sharing game, the processor 103b may transmit the invitation data to which information about the members of the combination is added. For example, with reference to the host-guest management data D2b, the processor 103b may add, to the invitation data, information about a combination of the invitation source as a host apparatus and a guest apparatus and the game session ID of a sharing game for which invitation has been made, and transmit the resultant invitation data to the game apparatus 1 of the invited member. In addition, if no participation data has been obtained from the invited member since a predetermined period of time before, the processor 103b may end transmission of the invitation data to the invited member, cancel registration of the guest apparatus candidate, and update the host-guest management data D2b.

In step S234, the processor 103b determines whether or not participation data has been received from a game apparatus 1. If participation data has been received, the processor 103b proceeds to step S235. Otherwise, i.e., if participation data has not been received, the processor 103b proceeds to step S237.

In step S235, the processor 103b registers a guest apparatus, and proceeds to the next step. For example, the processor 103b changes the registration of the transmission source of the received participation data from a guest apparatus candidate to a guest apparatus, and updates the host-guest management data D2b. In addition, for a combination for a sharing game in which a guest apparatus has been registered, if the game session ID has not been set, the processor 103b sets the game session ID of the sharing game for the combination, and updates the host-guest management data D2b.

Next, the processor 103b transmits participation information to a game apparatus 1 of a coplayer for the guest apparatus registered in step S235 (step S236), and proceeds to step S237. For example, the processor 103b transmits participation information indicating a newly registered guest apparatus (e.g., a user name) and the game session ID to a host apparatus and other guest apparatuses.

In step S237, the processor 103b determines whether or not operation data has been received from a game apparatus 1. If operation data has been received, the processor 103b proceeds to step S238. Otherwise, i.e., if operation data has not been received, the processor 103b proceeds to step S239.

In step S238, the processor 103b transmits the received operation data to a corresponding host apparatus, and proceeds to step S239. For example, the processor 103b retrieves a host apparatus that is combined with the transmission source (guest apparatus) of the operation data from the host-guest management data D2b, adds information about the guest apparatus that has transmitted the operation data and the game session ID to the operation data, and transmits the resultant operation data to the host apparatus.

In step S239, the processor 103b determines whether or not game image data has been received from a game apparatus 1. If game image data has been received, the processor 103b proceeds to step S240. Otherwise, i.e., if game image data has not been received, the processor 103b returns to and repeats step S231.

In step S240, the processor 103b transmits the received game image data to each corresponding guest apparatus, and returns to and repeats step S231. For example, the processor 103b retrieves a transmission destination to which the game image data is to be transmitted from a guest apparatus combined with the transmission source (host apparatus) of the game image data, with reference to the received game image data and the host-guest management data D2b, adds information about the host apparatus and the game session ID to the game image data, and transmits the resultant game image data to the guest apparatus as the transmission destination.

It should be noted that the steps in the flowcharts of FIGS. 13 to 20, 22, and 24, which are merely illustrative, may be executed in a different order, or another step may be executed in addition to and/or instead of each step, if a similar effect is obtained. In the present example, it is assumed that the processor 11, the processor 103a, or the processor 103b (CPU) executes each step of the flowcharts. Alternatively, a portion of the steps of the flowcharts may be executed by the processor 11, the processor 103a, or the processor 103b, and the other portion may be executed by a processor or dedicated circuit other than the processor 11, the processor 103a, or the processor 103b. Still alternatively, all of the steps of the flowcharts may be executed by a processor or dedicated circuit other than the processor 11, the processor 103a, or the processor 103b. In addition, a portion of the steps executed by the game apparatus 1, the server 101a, and the server 101b may be executed by another game apparatus that can communicate with the game apparatus 1, the server 101a, and the server 101b (e.g., another apparatus that can communicate with these apparatuses through a network). Specifically, the steps of FIGS. 13 to 20, 22, and 24 may be executed by a plurality of apparatuses including the game apparatus 1, the server 101a, and the server 101b cooperating with each other.

Thus, in the present example, a plurality of combinations of a host apparatus and a guest apparatus that execute a sharing game in the same communication group can be configured. Therefore, even when only a small number of members have a game program, a variety of sharing games can be executed in the communication group, and communication using a game can be expected to be promoted. In addition, voice chat and images can be shared between members belonging to the communication group, and therefore, a session for playing a sharing game can be easily formed.

Although in the above examples, a client-server system in which a plurality of game apparatuses 1 perform Internet communications through the server 101a or 101b is employed, other communications systems may be employed. In another example, a peer-to-peer communications system may be employed in which a plurality of game apparatuses 1 directly exchange data with each other without through a server. For example, at least one of data communication associated with the communication function executed through the server 101a and data communication associated with the game sharing function executed through the server 101b may be executed using a peer-to-peer communications system. In the case in which the former data communication is executed using a peer-to-peer communications system, the function of the group management unit 105 of the server 101a may be provided in each game apparatus 1. In the case in which the latter data communication is executed using a peer-to-peer communications system, the guest apparatus registration/management function of the game management unit 106 of the server 101b may be provided in the game sharing function for a host in each game apparatus 1, and the host apparatus registration/management function of the game management unit 106 of the server 101b may be provided in the game sharing function for a guest in each game apparatus 1.

In addition, in the case in which the peer-to-peer communications system is employed, data communication using said communications system may be either Internet communications or near-field wireless communication. For example, in another example, data communication associated with the communication function may be executed using Internet communications through the server 101a, and data communication associated with the game sharing function may be executed using near-field wireless communication employing the peer-to-peer communications system.

In addition, in the foregoing description, an example in which an information process (game process) is executed by the game apparatus 1 or the servers 101a and 101b. Alternatively, at least a portion of the above process steps may be performed in another apparatus. For example, in the case in which the game apparatus 1, the server 101a, and the server 101b can also communicate with another apparatus (e.g., another server, another game apparatus, another image display apparatus, another game apparatus, or another mobile terminal), the above process steps may be executed in cooperation with the another apparatus. By thus causing another apparatus to perform a portion of the above process steps, a process similar to the above process can be performed. The above information process may be executed by a single processor or a plurality of cooperating processors included in a computer system including at least one game apparatus. In the above examples, the information processes can be executed by the processor 11 of the game apparatus 1, the processor 103a of the server 101a, and the processor 103b of the server 101b executing respective predetermined programs. Alternatively, all or a portion of the above processes may be performed by a dedicated circuit(s) included in the game apparatus 1, the server 101a, and/or the server 101b.

Here, according to the above variation, the present example can be carried out in a so-called cloud computing system form or distributed wide-area and local-area network system forms. For example, in the distributed local-area network system form, the above process can be executed by cooperation between a stationary game apparatus and a mobile game apparatus (handheld game apparatus). It should be noted that in these system forms, each of the steps may be performed by substantially any of the apparatuses, and the present example may be implemented by assigning the steps to the apparatuses in substantially any manner.

The order of steps, setting values, conditions for determination, etc., used in the above information processes are merely illustrative, and of course, other order of steps, setting values, conditions for determination, etc., may be used to carry out the present example.

The above programs may be supplied to the game apparatus 1, the server 101a, and the server 101b not only through an external storage medium, such as an external memory, but also through a wired or wireless communications line. The above programs may be previously stored in a non-volatile storage device in the apparatus. Examples of an information storage medium storing the above programs include non-volatile memories, and in addition, CD-ROMs, DVDs, optical disc-like storage media similar thereto, and flexible disks, hard disks, magneto-optical disks, and magnetic tapes. The information storage medium storing the above programs may be a volatile memory storing the above programs. Such a storage medium may be referred to as a storage medium that can be read by a computer, etc. (a computer-readable storage medium, etc.). For example, the above various functions can be provided by causing a computer, etc., to read and execute programs from these storage media. In addition, the above programs may be executed by an interpreter or emulator.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

Thus, the present example is applicable to computer systems, computer-implemented methods, game apparatuses, and the like that have the function of distributing images from a host apparatus to a guest apparatus, and are capable of executing a game and the like using novel and various methods.

What is claimed is:

1. A computer system comprising a plurality of computers, wherein
each computer comprises one or more processors and one or more memories storing instructions,
each computer is configured to perform operations comprising:
forming a group including the plurality of computers, and performing voice chat by communication of audio data in the group through or without through a server; and
executing a sharing game that is provided by one of the plurality of computers that executes a game program and in which another one of the plurality of computers is allowed to participate without executing the game program, by communication of operation data and game image data between the plurality of computers, and
the executing the sharing game includes any one of
executing, as a host, host processes including a game process based on operation data of a self-computer and operation data of another one of the plurality of computers serving as a guest obtained by communications to generate a game image, and transmission of the generated game image data to the another one of the plurality of computers serving as a guest, or
executing, as a guest, guest processes including transmission of the operation data of the self-computer to another one of the plurality of computers serving as a host, reception of game image data from the another one of the plurality of computers serving as a host, and displaying of a game image, and
the executing the host processes is allowed to be activated no matter whether or not the executing the host processes is performed by another one of the plurality of computers in the group.

2. The computer system according to claim 1, wherein
the operations further comprise sharing game images displayed on screens of at least four other ones of the plurality of computers belonging to the group of the self-computer, by simultaneously outputting and displaying the game images to and on a screen of the self-computer.

3. The computer system according to claim 1, wherein
the executing the host processes further includes:
transmitting invitation data to the sharing game to another one of the plurality of computers, the another one of the plurality of computers receiving the invitation data and transmitting participation data in response to the reception, thereby setting a member of the sharing game;
displaying, as a candidate for a transmission destination of the invitation data, candidates including at least another one of the plurality of computers belonging to the group of the self-computer;
selecting a transmission destination from the displayed candidates according to a user's operation; and
transmitting the invitation data to the transmission destination selected by the selecting a transmission destination, and
the candidates include only one or ones of the plurality of computers in the group of the self-computer.

4. The computer system according to claim 1, wherein
a communications channel for executing the voice chat is different from a communications channel for executing the sharing game.

5. The computer system according to claim 2, wherein
the operations further comprise displaying an indication indicating that the sharing game is being executed, in association with display of a game image displayed on the screen of the self-computer.

6. The computer system according to claim 1, wherein
the executing the host processes further includes:
transmitting invitation data to the sharing game to another one of the plurality of computers, the another one of the plurality of computers receiving the invitation data and transmitting participation data in response to the reception, thereby setting a member of the sharing game; and
transmitting the invitation data to another one of the plurality of computers that has already been executing, as a guest, the sharing game with still another one of the plurality of computers, and
the executing the guest processes further includes:
receiving the invitation data from another one of the plurality of computers during execution of the sharing game, and transmitting participation data in response to the received invitation data, thereby executing, instead of the sharing game that is being executed, another sharing game together with the another one of the plurality of computers that has transmitted the invitation data.

7. A computer-implemented method executed by a computer system including a plurality of computers, the method comprising:
forming a group including the plurality of computers, and performing voice chat by communication of audio data in the group through or without through a server; and
executing a sharing game that is provided by one of the plurality of computers that executes a game program and in which another one of the plurality of computers is allowed to participate, by communication of operation data and game image data between the plurality of computers, and
the executing the sharing game includes:
causing at least one of the plurality of computers to execute, as a host, host processes including a game process based on operation data of the at least one of the plurality of computers and operation data of another one of the plurality of computers serving as a guest obtained by communications to generate a game image, and transmission of the generated game image data to the another one of the plurality of computers serving as a guest; and
causing at least another one of the plurality of computers to execute, as a guest, guest processes including transmission of the operation data of the at least another one of the plurality of computers to still another one of the plurality of computers serving as a host, reception of game image data from the still another one of the plurality of computers serving as a host, and displaying of a game image, and
the executing the host processes is allowed to be activated no matter whether or not the executing the host processes is performed by another one of the plurality of computers in the single group.

8. The computer-implemented method according to claim 7, further comprising:
sharing game images displayed on screens of at least four other ones of the plurality of computers belonging to the group of one of the plurality of computers, by simultaneously outputting and displaying the game images to and on a screen of the one of the plurality of computers.

9. The computer-implemented method according to claim 7, wherein
the executing the host processes further includes:
transmitting invitation data to the sharing game to another one of the plurality of computers, the causing the another one of the plurality of computers to execute as a guest receiving the invitation data and transmitting participation data in response to the reception, thereby setting a member of the sharing game;
displaying, as a candidate for a transmission destination of the invitation data, candidates including at least another one of the plurality of computers belonging to the group of the at least one of the plurality of computers;
selecting a transmission destination from the displayed candidates according to a user's operation; and
transmitting the invitation data to the transmission destination selected by the selecting a transmission destination, and
the candidates include only one or ones of the plurality of computers in the group of the at least one of the plurality of computers.

10. The computer-implemented method according to claim 7, wherein
a communications channel for executing the voice chat is different from a communications channel for executing the sharing game.

11. The computer-implemented method according to claim 8, wherein
an indication indicating that the sharing game is being executed is displayed in association with display of a game image displayed on a screen of the one of the plurality of computers.

12. The computer-implemented method according to claim 7, wherein
the executing the host processes further includes:
transmitting invitation data to the sharing game to another one of the plurality of computers, the another one of the plurality of computers receiving the invitation data and transmitting participation data in response to the reception, thereby setting a member of the sharing game; and
transmitting the invitation data to one of the plurality of computers that has already been executing, as a guest, the sharing game with another one of the plurality of computers, and
the executing the guest processes further includes:
receiving the invitation data during execution of the sharing game, and
transmitting participation data in response to the received invitation data, thereby executing, instead of the sharing game that is being executed, another sharing game together with one of the plurality of computers that has transmitted the invitation data.

13. A game apparatus comprising one or more processing circuitry and one or more memories storing instructions that cause the one or more processing circuitry to perform operations comprising:
together with another game apparatus, forming a group, and performing voice chat by communication of audio data in the group through or without through a server; and
executing a sharing game in which the another game apparatus is allowed to participate in a game executed by one game apparatus without executing the game, by communication of operation data and game image data with the another game apparatus, and
the executing the sharing game includes any one of
executing, as a host, host processes including a game process based on operation data of the self-game apparatus and operation data of a guest game apparatus obtained by communications to generate a game image, and transmission of the generated game image data to the guest game apparatus, or
executing, as a guest, guest processes including transmission of the operation data of the self-game apparatus to a host game apparatus, reception of game image data from the host game apparatus, and displaying of a game image, and
the executing the host processes is allowed to be activated no matter whether or not the executing the host processes is performed by the another game apparatus in the group.
